(19) United States
(12) Patent Application Publication
(10) Pub. No.: US 2024/0079575 A1
(43) Pub. Date: Mar. 7, 2024

(54) SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Yumiko SEKIGUCHI, Kawasaki Kanagawa (JP); Keigo HOSHINA, Yokohama Kanagawa (JP); Kazuomi YOSHIMA, Yokohama Kanagawa (JP); Yasuyuki HOTTA, Tokyo (JP); Hayato SEKI, Kawasaki Kanagawa (JP); Hirofumi YASUMIISHI, Kawasaki Kanagawa (JP); Wataru UNO, Yokohama Kanagawa (JP)

(73) Assignee: KABUSHIKI KAISHA TOSHIBA, Tokyo (JP)

(21) Appl. No.: 18/172,881

(22) Filed: Feb. 22, 2023

(30) Foreign Application Priority Data
Sep. 2, 2022 (JP) 2022-139992

(51) Int. Cl. H01M 4/485; H01M 10/0525; H01M 50/446

(52) U.S. Cl. CPC H01M 4/485; H01M 10/0525; H01M 50/446; H01M 2004/021; H01M 2220/20

(57) ABSTRACT

Provided is a secondary battery including a negative electrode, a positive electrode, a separation layer in contact with an active material-containing layer of the negative electrode, and an aqueous electrolyte. A first concentration corresponding to a first metal concentration represented by Equation 1 (first metal concentration=atomic concentration of Hg, Pb, Zn, and/or Bi/sum of atomic concentrations of elements B to U in periodic table, excluding carbon and oxygen) in a boundary region between the active material-containing layer and the separation layer is 2% or more and 8.2% or less. A ratio of the first concentration to a second concentration corresponding to the first metal concentration represented by Equation 1 in the active material-containing layer excluding the boundary region is 2.5 or more and less than 4.

### CROSS-REFERENCE TO RELATED APPLICATIONS

This application is based upon and claims the benefit of priority from Japanese Patent Application No. 2022-139992, filed Sep. 2, 2022, the entire contents of which are incorporated herein by reference.

### FIELD

Embodiments described herein relate generally to a secondary battery, a battery pack, a vehicle, and a stationary power supply.

### BACKGROUND

A nonaqueous electrolyte battery using a carbon material or a lithium titanium oxide as a negative electrode active material and a layered oxide that contains nickel, cobalt or manganese as a positive electrode active material, a lithium secondary battery in particular, has already been in practical use as a power source in a wide range of fields. Such a nonaqueous electrolyte battery is provided in a variety of forms, from small-sized batteries such as those for various electronic devices to large-sized batteries such as those for electric automobiles. For an electrolyte solution of the lithium secondary battery, a nonaqueous organic solvent prepared by mixing ethylene carbonate, methyl ethyl carbonate and the like is used, unlike a nickel-hydrogen battery or a lead storage battery. An electrolyte solution prepared using such a solvent has a higher oxidation resistance and a higher reduction resistance as compared to those of an aqueous electrolyte solution, whereby electrolysis of the solvent hardly occurs. Thus, with a nonaqueous lithium secondary battery, a high electromotive force of from 2 V to 4.5 V can be realized.

Meanwhile, many organic solvents are flammable substances. Accordingly, the safety of a secondary battery formed using an organic solvent is theoretically inferior to that of a secondary battery formed using an aqueous solution. In order to improve the safety of a lithium secondary battery using an electrolyte solution containing an organic solvent, various countermeasures have been made; however, one cannot be certain that the countermeasures are sufficient. In addition, the production process of the nonaqueous lithium secondary battery requires a dry environment, thereby inevitably increasing the production cost. Moreover, the electrolyte solution containing an organic solvent is inferior in electrical conductivity, whereby an internal resistance of the nonaqueous lithium secondary battery is apt to increase. Such problems are great draw backs for applications in electric vehicles or hybrid electric vehicles and large-sized storage batteries for stationary energy storage, for which battery safety and cost are regarded to be of importance.

In order to resolve the problems found in nonaqueous secondary batteries, secondary batteries using an aqueous solution electrolyte have been proposed. However, due to electrolysis of the aqueous solution electrolyte, the active material is apt to fall off the current collector, and therefore, operation of the secondary battery had not stabilized, posing a problem against satisfactory charge and discharge. In order to perform satisfactory charge and discharge, in the case an aqueous solution electrolyte is used, a countermeasure that can be taken is limitation of the potential range for performing charge and discharge of the battery to a potential range at which an electrolysis reaction of water contained as a solvent does not occur. For example, by using a lithium manganese oxide as the positive electrode active material and using a lithium vanadium oxide as the negative electrode active material, electrolysis of aqueous solvent can be avoided. In the case of such a combination, while an electromotive force of from 1 V to 1.5 V can be obtained, an energy density sufficient as a battery is hardly obtained.

On the contrary, when a lithium manganese oxide is used as the positive electrode active material and a lithium titanium oxide such as LiTi₂O₄ or Li₄Ti₅O₁₂ is used as the negative electrode active material, an electromotive force of about 2.6 V to 2.7 V can be theoretically obtained, and the battery may also be attractive from the viewpoint of energy density. With a nonaqueous lithium ion battery adopting such a combination of the positive and negative electrode materials, excellent life performance is obtained and such a battery has already been in practical use.

However, in the aqueous solution electrolyte, a lithium insertion/extraction potential of lithium titanium oxide is about 1.5 V (vs. Li/Li⁺) based on lithium potential, and thus, electrolysis of the aqueous solution electrolyte easily occurs. For the negative electrode in particular, hydrogen is vigorously generated by electrolysis on the surface of a negative electrode current collector or a metal outer can electrically connected to the negative electrode. Due to an influence thereof, the active material is apt to fall off the current collector. Consequently, operation does not stabilize in such a battery, whereby satisfactory charge-discharge cycle had not been possible.

Many titanium-containing oxides including spinel lithium titanium oxide Li₄Ti₅O₁₂ (TLO) have lower operating potentials than the electrolysis potential of water. Thus, for example, in a secondary battery using a titanium-containing oxide such as TLO as a negative electrode active material and containing a large amount of water in the electrolyte solution, not only does the negative electrode active material fall off due to bubbles of hydrogen generated by electrolysis of water, but also, an insertion reaction of carriers (for example, alkali metal ions such as lithium ions) into the negative electrode active material and a reduction reaction of protons (hydrogen cation; H1 by electrolysis of water compete. As a result, the charge-discharge efficiency and the discharge capacity of the secondary battery deteriorate.

### BRIEF DESCRIPTION OF THE DRAWINGS

FIG. 1 is a cross-sectional view schematically illustrating an example of an electrode group that can be included in a secondary battery according to an embodiment.

FIG. 2 is a cross-sectional view schematically illustrating an example of a sample piece of a negative electrode composite that can be included in the secondary battery according to the embodiment.

FIG. 3 is an enlarged cross-sectional view of a section A of the sample piece illustrated in FIG. 2.

FIG. 4 is a cross-sectional view schematically illustrating an example of the secondary battery according to the embodiment.

FIG. 5 is a cross-sectional view of the secondary battery illustrated in FIG. 4 taken along line V-V.

FIG. 6 is a partially cutaway perspective view schematically illustrating another example of the secondary battery according to the embodiment.

FIG. 7 is an enlarged cross-sectional view of a section B of the secondary battery illustrated in FIG. 6.

FIG. 8 is a perspective view schematically illustrating an example of a battery module according to an embodiment.

FIG. 9 is a perspective view schematically illustrating an example of a battery pack according to an embodiment.

FIG. 10 is an exploded perspective view schematically illustrating another example of the battery pack according to the embodiment.

FIG. 11 is a block diagram illustrating an example of an electric circuit of the battery pack illustrated in FIG. 10.

FIG. 12 is a cross-sectional view schematically illustrating an example of a vehicle according to an embodiment.

FIG. 13 is a block diagram illustrating an example of a system including a stationary power supply according to an embodiment.

### DETAILED DESCRIPTION

According to one embodiment, provided is a secondary battery including: a negative electrode, the negative electrode including a negative electrode active material-containing layer that contains a titanium-containing oxide; a positive electrode; a separation layer in contact with the negative electrode active material-containing layer and positioned between the negative electrode and the positive electrode; and an aqueous electrolyte. At least one of the negative electrode active material-containing layer and the separation layer contains one or more first metal element selected from the group consisting of Hg, Pb, Zn, and Bi. A first concentration corresponding to a first metal concentration in a boundary region spanning over 10 μm in a thickness direction including a boundary between the negative electrode active material-containing layer and the separation layer is 2% or more and 8.2% or less. The first metal concentration is represented by Equation 1 given below. A ratio of the first concentration to a second concentration corresponding to the first metal concentration in a region among the negative electrode active material-containing layer excluding the boundary region is 2.5 or more and less than 4.

first metal concentration=atomic concentration of first metal element/sum of atomic concentrations of elements B to U in periodic table excluding carbon and oxygen Equation 1:

According to another embodiment, a battery pack including the secondary battery according to the above embodiment is provided.

According to yet another embodiment, a vehicle including the battery pack according to the above embodiment is provided.

According to still another embodiment, a stationary power supply including the battery pack according to the above embodiment is provided.

Hereinafter, embodiments will be described with reference to the drawings. The same reference signs are applied to common components throughout the embodiments and overlapping explanations are omitted. Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to a first embodiment, a secondary battery including a negative electrode, a positive electrode, a separation layer, and an aqueous electrolyte is provided. The negative electrode includes a negative electrode active material-containing layer. The negative electrode active material-containing layer contains a titanium-containing oxide. The separation layer is in contact with the negative electrode active material-containing layer and is positioned between the negative electrode and the positive electrode. At least one of the negative electrode active material-containing layer and the separation layer contains one or more first metal elements selected from the group consisting of Hg, Pb, Zn, and Bi. A first concentration that corresponds to a first metal concentration, which is represented by Equation 1 shown below, in a boundary region between the negative electrode active material-containing layer and the separation layer is from 2% to 8.2%. A ratio of the first concentration with respect to a second concentration is 2.5 or more and less than 4, where the second concentration corresponds to the first metal concentration within a region among the negative electrode active material-containing layer excluding the boundary region. The boundary region indicates a region including the boundary between the negative electrode active material-containing layer and the separation layer, and is a region that spans over 10 μm in a thickness direction of the negative electrode active material-containing layer and the separation layer.

$$First metal concentration = \frac{\begin{matrix}Atomic concentration \\ of first metal element\end{matrix}}{\begin{matrix}\begin{matrix}\begin{matrix}Sum of atomic concentrations \\ of elements B to U in\end{matrix} \\ periodic table\end{matrix} \\ excluding carbon and oxygen\end{matrix}} \qquad ( 1 )$$

As one method of suppressing water splitting at the negative electrode, there can be mentioned a method of forming a coating film on the surface of the negative electrode active material-containing layer. As the coating film, known is a metal coating film containing a metal having high hydrogen generation overvoltage. Examples of the metal having high hydrogen generation overvoltage include zinc.

As another method, there can be mentioned a use of a separator whose denseness is high enough to exhibit a high water shielding property. An example of the separator having particularly high denseness is a solid electrolyte membrane. The solid electrolyte membrane is a membrane configured only of solid electrolyte particles having ion conductivity. While the solid electrolyte membrane selectively allows certain ions to permeate therethrough, solvents hardly permeate through the solid electrolyte membrane; therefore, the solid electrolyte membrane exhibits water shielding properties. Otherwise, there has been proposed a polymer composite membrane where solid electrolyte particles are bound to each other by a polymer material. The polymer composite membrane has a water shielding property lower than that of the solid electrolyte membrane, but has a high denseness and can retain a small amount of aqueous electrolyte. In addition, as compared with the solid electrolyte membrane, the polymer composite membrane is excellent in flexibility and can be made into a thin film.

As still another method, there can be mentioned a method of adjusting the composition of the electrolyte solution, which is an aqueous solution, itself. For example, in a strongly basic aqueous electrolyte, the hydrogen generation potential is low. Moreover, the electrolysis of water in the solvent can be suppressed by having the aqueous electrolyte contain various additives. Examples of the additive include an organic solvent and a nonionic surfactant.

In the secondary battery according to the embodiment, water splitting at the negative electrode as well as hydrogen production due to that can be further suppressed. In a secondary battery with an aqueous electrolyte, replenishment of water molecules from the positive electrode contributes to facilitating the occurrence of the water splitting at the negative electrode. In the secondary battery according to the embodiment, the water splitting can be suppressed at the boundary between the negative electrode and the separation layer separating the negative electrode from the positive electrode. Therefore, high charge-discharge efficiency and cycle life performance can be exhibited.

Next, the secondary battery according to the embodiment will be described in detail.

The secondary battery may be, for example, a lithium secondary battery (lithium ion secondary battery). The secondary battery may be, for example, a sodium secondary battery (sodium ion secondary battery). The secondary battery includes an aqueous electrolyte secondary battery containing an aqueous electrolyte (for example, an aqueous solution electrolyte). In other words, the secondary battery may be an aqueous electrolyte lithium ion secondary battery, or an aqueous electrolyte sodium ion secondary battery.

In the secondary battery, the negative electrode, the positive electrode, and the separation layer may configure an electrode group. The secondary battery may further include a container member capable of housing the electrode group and the aqueous electrolyte. In addition, the secondary battery may further include a negative electrode terminal electrically connected to the negative electrode and a positive electrode terminal electrically connected to the positive electrode.

The separation layer is in contact with the surface of the negative electrode active material-containing layer that faces toward the positive electrode. The separation layer is desirably bound to the negative electrode active material-containing layer. For example, the separation layer may be one formed on the surface of the negative electrode active material-containing layer. Herein, a structure configured of a negative electrode and a separation layer provided on the surface of the negative electrode active material-containing layer may be referred to as a negative electrode composite. The separation layer serves as a separator that electrically insulates the negative electrode from the positive electrode.

The secondary battery may further include, in addition to the separation layer, another separator independent from the separation layer. The other separator may be provided, for example, between the separation layer and the positive electrode. The other separator may be impregnated with an aqueous electrolyte.

At least one of the negative electrode active material-containing layer and the separation layer contains one or more first metal element(s) selected from the group consisting of Hg, Pb, Zn, and Bi, and the distribution of the first metal elements in the negative electrode composite is not uniform but rather has a tendency for the first metal concentration to be higher in the vicinity of the boundary between the negative electrode active material-containing layer and the separation layer. Specifically, the ratio of the first concentration of the first metal element in the boundary region to the second concentration of the first metal element in regions of the negative electrode active material-containing layer excluding the boundary region is 2.5 or more and less than 4, as determined according to scanning electron microscope-energy dispersive X-ray spectrometry (SEM-EDX) described later. In addition, the first concentration is 2% or more and 8.2% or less in percentage of atomic concentration.

The first metal element is a metal having high hydrogen generation overvoltage. Among the first metal elements, at least zinc is desirably included. Therefore, the first metal element desirably contains at least zinc. The first metal element may be contained in the negative electrode active material-containing layer and/or the separation layer, for example, in one or more forms selected from the group consisting of a simple substance of the metal, an oxide, a chloride, a nitrate, a sulfate, and a hydroxide of the first metal element. For example, a simple substance or a compound of the first metal element may be in a state of covering the surfaces of particles of the negative electrode active material or the like contained in the boundary region in the negative electrode active material-containing layer.

The boundary region as used herein refers to a region of 10 μm thickness that crosses the boundary between the negative electrode active material-containing layer and the separation layer in contact therewith, that is, an interface therebetween. Here, the direction that intersects the interface between the negative electrode active material-containing layer and the separation layer is regarded as the thickness direction. Further, both the first concentration and the second concentration are represented by Equation 1 (First metal concentration=[Atomic concentration of first metal element/sum of the atomic concentrations of elements B to U in periodic table excluding carbon and oxygen]). In the sum of the atomic concentrations of each of elements B to U excluding carbon and oxygen as expressed in Equation 1 included in the boundary region between the negative electrode active material-containing layer and the separation layer and the regions of the negative electrode active material-containing layer other than the boundary region in the secondary battery, the constituent elements of the negative electrode active material contained in the negative electrode active material-containing layer and of the material contained in the separation layer may be included, in addition to the first metal element. For example, in a case where spinel lithium titanate Li₄Ti₅O₁₂ is used as the negative electrode active material and a LATP compound represented by Li₁₊ₓAlₓTi₂₋ₓ(PO₄)₃ (0.1≤x≤0.5) is used for the separation layer, the denominator on the right-side of Equation 1 may be equivalent to the sum of the atomic concentrations (at. %) of the first metal element, titanium (Ti), aluminum (Al), and phosphorus (P).

Since the content of the first metal element in the negative electrode composite is higher in the boundary region than that in the other regions, water splitting of water molecules supplied from the positive electrode side can be effectively suppressed. Since the first metal element is localized in the boundary region rather than being present sparsely over the entire negative electrode active material-containing layer, water decomposition apt to occur in vicinity of the interface between the negative electrode and the separation layer, and self-discharge and hydrogen generation associated therewith can be suppressed. Therefore, the secondary battery according to the embodiment can exhibit high charge-discharge efficiency and cycle life performance. Methods of determining the first concentration, the second concentration, and the ratio thereof will be described. The atomic concentrations of the first metal element and other elements (excluding carbon and oxygen) in Equation (1) can be determined by elemental analysis with a scanning electron microscope equipped with an energy dispersive X-ray spectrometry scanning apparatus (SEM-EDX). By SEM-EDX analysis, compositions of the components contained in the negative electrode active material-containing layer and the separation layer (each element from B to U in the periodic table) can be known. As described below, the first concentration and the second concentration are ascertained based on cross-sectional observation using the SEM with respect to the negative electrode composite configured from the negative electrode and the separation layer, and EDX analysis.

The secondary battery is discharged, and thereafter, the battery is disassembled and the negative electrode composite is taken out. Specifically, the electrode group is taken out from the battery, and the positive electrode is separated from the electrode group, whereby the negative electrode composite can be obtained. The negative electrode composite taken out is rinsed and washed three times with an amount of pure water in which the negative electrode composite is fully immersed. After washing with pure water, the negative electrode composite is dried, for example, at 120° C. for 1 hour. After drying, a sample piece having an area corresponding to 0.1% of the area of the principal surface of the negative electrode composite is cut out from the central portion of the principal surface. For example, a sample piece of 2 mm square is cut out from a negative electrode composite having a principal surface area of 6 cm×8 cm. The principal surface may, for example, lie along the direction of the interface between the negative electrode active material-containing layer and the separation layer.

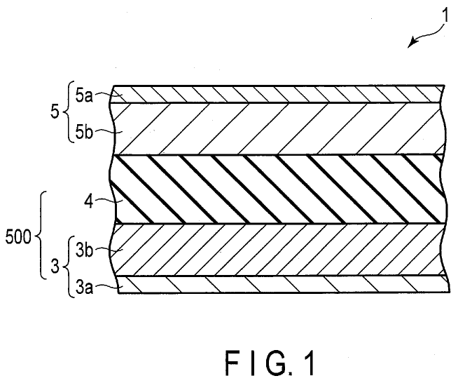

The electrode group may include the structure shown in FIG. 1, for example. FIG. 1 is a cross-sectional view schematically showing an example of an electrode group that may be included in the secondary battery according to the embodiment. The electrode group 1 shown in FIG. 1 includes a negative electrode 3, a positive electrode 5, and a separation layer 4 positioned between the negative electrode 3 and the positive electrode 5. The negative electrode 3 includes a negative electrode current collector 3a and a negative electrode active material-containing layer 3b supported on one of the principal surfaces of the negative electrode current collector 3a. The negative electrode 3 and the separation layer 4 configure a negative electrode composite 500. The positive electrode 5 includes a positive electrode current collector 5a and a positive electrode active material-containing layer 5b supported on one of the principal surfaces of the positive electrode current collector a.

In the example illustrated in FIG. 1, the negative electrode active material-containing layer 3b is provided only on one principal surface of the negative electrode current collector 3a in the negative electrode 3, but the negative electrode active material-containing layer 3b may be provided on each principal surface on both sides of the negative electrode current collector 3a. Similarly, in the positive electrode 5, the positive electrode active material-containing layer 5b may be provided on each principal surface on both sides of the positive electrode current collector 5a.

The separation layer 4 is in contact with the negative electrode active material-containing layer 3b, and may be supported on the negative electrode active material-containing layer 3b. In the exemplified electrode group 1, the separation layer 4 is also in contact with the positive electrode active material-containing layer 5b on the reverse surface. In the secondary battery, there may be a case where a negative electrode composite 500 and a positive electrode 5 are included in a state where the separation layer 4 and the positive electrode active material-containing layer 5b are not in direct contact with each other.

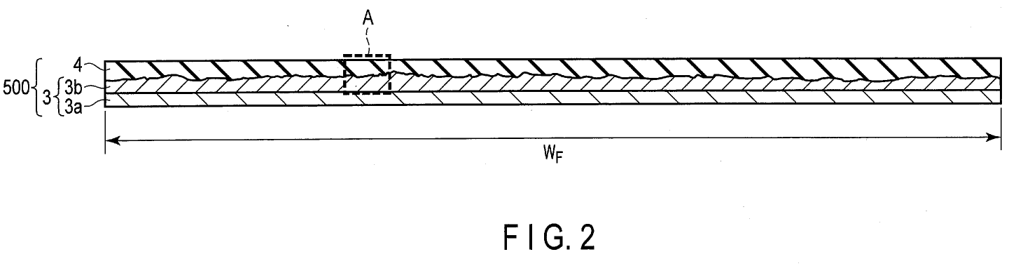

The negative electrode composite 500 can be obtained by removing the positive electrode 5 from the electrode group 1 illustrated in FIG. 1. After washing with water and drying, the sample piece is cut out from the negative electrode composite 500 as described above. From the cut sample piece, a cross-section in the thickness direction of the negative electrode composite 500 including the negative electrode 3 and the separation layer 4 is milled out by Ar ion milling. An example of the sample piece is illustrated in FIG. 2. The sample piece of the negative electrode composite 500 illustrated in FIG. 2 includes: a negative electrode 3 including a negative electrode current collector 3a and a negative electrode active material-containing layer 3b provided thereon; and a separation layer 4 provided on the negative electrode 3. SEM-EDX analysis is performed on the cross-section where the negative electrode 3 and the separation layer 4 are visible.

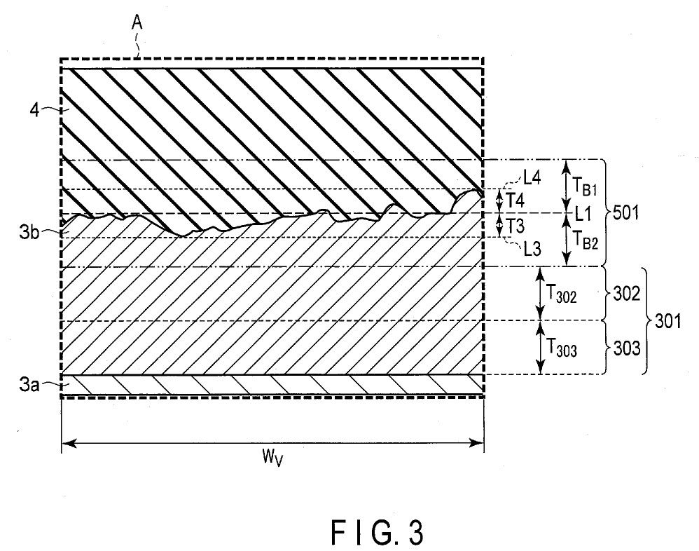

The SEM measurement is performed at a magnification yielding a field of view completely including the negative electrode 3 and the separation layer 4 included in the sample piece, for example, at 2000-fold magnification. On the obtained SEM image, EDX analysis is performed at one or more points within the observed cross-section having a width corresponding to 5% of the width W_{F} of the sample piece. For example, a part corresponding to the section A illustrated in FIG. 2 is chosen as a point where EDX analysis is performed. In FIG. 3, an enlarged cross-sectional view of the section A in FIG. 2 is illustrated as an example of an EDX analysis point.

FIG. 3 is an enlarged cross-sectional view schematically illustrating an example of a point as an observation field of view when performing EDX analysis. Taking the thickness direction of the sample piece of the negative electrode composite 500 as the longitudinal direction, the lateral width W_{V} of the observation field of view corresponds to 5% of the width W_{F} of the entire sample piece (W_{V}/W_{F}=5%). Here, the lateral direction of the observation field of view may lie along the interface between the negative electrode current collector 3a and the negative electrode active material-containing layer 3b, for example. In a case where two or more points in the sample piece are chosen as observation fields of view to be subjected to EDX analysis, each lateral width W_{V} corresponds to 5% of the width W_{F} of the entire sample piece. Note that, instead of arbitrarily selecting each observation field of view, the observation fields of view are chosen so as to be arranged at equal intervals along one side (width W_{F}) of the sample piece.

In the observation field of view, the boundary region in the negative electrode composite is specified as follows. As illustrated in FIG. 3, the interface between the negative electrode active material-containing layer 3b and the separation layer 4 is not always flat, and the negative electrode active material-containing layer 3b and the separation layer 4 may partially protrude toward one another. In the observation field of view, an imaginary line L4 passing through the vertex of the negative electrode active material-containing layer 3b that protrudes most toward the separation layer 4 in the observation field of view and an imaginary line L3 passing through the vertex of the separation layer 4 that protrudes most toward the negative electrode in the observation field of view are respectively drawn as illustrated in FIG. 3. An imaginary line L1 is drawn in the middle between the imaginary line L4 and the imaginary line L3. Here, the distance T4 in the thickness direction from the imaginary line L4 on the separation layer 4 side to the intermediate imaginary line L1 is made equal to the distance T3 in the thickness direction from the imaginary line L3 on the negative electrode side to the imaginary line L1. A range of a thickness of 10 μm in total, taking a thickness T_{B1} of 5 μm from the imaginary line L1 toward the separation layer 4 and a thickness T_{B2} of 5 μm from the imaginary line L1 toward the negative electrode, is defined as a boundary region 501.

Of the separation layer 4 and the negative electrode active material-containing layer 3b, elemental analysis by EDX is performed on a portion included in the boundary region 501. Using the obtained atomic concentrations of various elements in the boundary region 501, the first concentration is calculated by Equation 1 described above.

The region 301 of the rest of the negative electrode active material-containing layer 3b excluding the boundary region 501 is divided into two portions in the thickness direction, portions 302 and 303 respectively on the boundary side and the current collector side, having equivalent thicknesses 1302 and 1303, respectively. The elemental analysis by EDX is performed on each of the portions 302 and 303 of the rest on the boundary side and the current collector side. With use of the atomic concentrations of various elements obtained for the portion 302 on the boundary side, the first metal concentration is calculated by Equation 1 described above. Similarly, with use of the atomic concentrations of various elements obtained for the portion 303 on the current collector side, the first metal concentration is calculated by Equation 1 described above. The average of the first metal concentrations calculated for each of the portions 302 and 303 on the boundary side and current collector side is adopted as a second concentration. In addition, by dividing the first concentration calculated for the boundary region 501 by the second concentration, the ratio thereof can be calculated.

According to the method described above, in the secondary battery according to the embodiment, in at least one point of observation field of view (width W_{V}=W_{F}×5%) in the cross-section of one side of the sample piece (FIG. 2) of the negative electrode composite 500, the first concentration is 2% or more and 8.2% or less, and the ratio of the first concentration to the second concentration is 2.5 or more and less than 4.

Having the ratio of the first concentration to the second concentration (first concentration/second concentration) determined by the method described above being 1 or more means that the first metal concentration is locally high in the boundary region 501. That is, since the first concentration and the second concentration respectively correspond to the first metal concentration in the boundary region 501 and the region 301 other than the boundary region 501, in a case where the ratio is 1 or more, the first metal concentration is high in the boundary region 501, and the distribution of the first metal is ununiform within the negative electrode active material-containing layer 3b.

Hereinafter, the negative electrode, positive electrode, separation layer, other separator, aqueous electrolyte, container member, negative electrode terminal, and positive electrode terminal will be described in detail.

### (1) Negative Electrode

The negative electrode includes a negative electrode active material-containing layer that contains a titanium-containing oxide. The negative electrode may further include a negative electrode current collector. The titanium-containing oxide may be contained in the negative electrode active material-containing layer as a negative electrode active material.

The negative electrode active material-containing layer is provided on, for example, at least one surface of the negative electrode current collector. The negative electrode active material-containing layer may be provided on one of the principal surfaces of the negative electrode current collector. Alternatively, the negative electrode active material-containing layer may be arranged on one of the principal surfaces of the current collector and the other principal surface on the reverse side.

The negative electrode active material-containing layer may include an electro-conductive agent, a binder, etc. in addition to the negative electrode active material. The electro-conductive agent is added as necessary to improve the current collection performance of the negative electrode and to suppress the contact resistance between the active material and the current collector. The binder has an action of binding the active material, the electro-conductive agent, and the current collector.

The negative electrode current collector is preferably a foil that contains, for example, at least one selected from the group consisting of aluminum (Al), titanium (Ti) and zinc (Zn). The form of the negative electrode current collector may be, for example, a mesh or a porous body, besides a foil. To increase the energy density and improve the output, the shape of a foil having a small volume and a large surface area is desirable.

A thickness of the negative electrode current collector is preferably in the range of 5 μm to 20 μm. A current collector having such a thickness can maintain balance between the electrode strength and weight reduction.

In addition, the negative electrode current collector may include a portion on a surface thereof, where the negative electrode active material-containing layer is not disposed thereon. The portion can serve as a negative electrode current collecting tab. Alternatively, a negative electrode current collecting tab separate from the negative electrode current collector may be electrically connected to the negative electrode.

As the titanium-containing oxide used for the negative electrode active material, there may be used a compound having a lithium insertion-extraction potential of 1 V (vs. Li/Li⁺) or greater and 3 V (vs. Li/Li⁺) or less relative to the oxidation-reduction potential of lithium as standard. In the secondary battery according to the embodiment, the boundary region between the negative electrode-containing layer and the separation layer is a region rich with zinc. Therefore, even with the negative electrode active material including the titanium-containing oxide having a low potential as mentioned above, charge and discharge can be performed properly in the aqueous electrolyte.

As the titanium-containing oxide, an oxide of titanium, lithium titanium composite oxide, monoclinic niobium titanium oxide, sodium niobium titanium composite oxide, and the like may be used. The negative electrode active material may include one species or two or more species of titanium-containing oxide.

Examples of the oxide of titanium include titanium oxide having a monoclinic structure, titanium oxide having a rutile structure, and titanium oxide having an anatase structure. For the titanium oxide having each of the crystal structures, the composition before charge can be represented as TiO₂ and the composition after charge can be represented as LiₓTiO₂ (subscript x is 0≤x≤1).

Further, for the titanium oxide having the monoclinic structure, the structure before charge can be represented as TiO₂(B).

Examples of the lithium titanium oxide include a lithium titanium oxide having a spinel structure (e.g., a compound represented by Li₄₊ₓTi₅O₁₂ where −1≤x≤3), a lithium titanium oxide having a ramsdellite structure (e.g., a compound represented by Li₂₊ₓTi₃O₇ where −1≤x≤3, a compound represented by Li₁₊ₓTi₂O₄ where 0≤x≤1, a compound represented by Li_{1.1+x}Ti_{1.8}O₄ where 0≤x≤1, a compound represented by Li_{1.07+x}Ti_{1.86}O₄ where 0≤x≤1, and a compound represented by LiₓTiO₂ where 0≤x≤1), and the like. The lithium titanium oxide may be a lithium-titanium composite oxide having a dopant introduced therein.

Examples of the monoclinic niobium titanium oxide include a compound represented by LiₓTi_{1-y}M1_{y}Nb_{2-z}M2_{z}O_{7+δ}.

Here, M1 is at least one selected from the group consisting of Zr, Si, and Sn. M2 is at least one selected from the group consisting of V, Ta, and Bi. The respective subscripts in the composition formula are specified as follows: 0≤x≤5, 0≤y<1, 0≤z<2, and —0.3≤δ≤0.3. Specific examples of the monoclinic niobium titanium oxide include LiₓNb₂TiO₇ (0≤x≤5).

Another example of the monoclinic niobium titanium oxide is a compound represented by LiₓTi_{1-y}M3_{y+z}Nb_{2-z}O_{7-δ}. Here, M3 is at least one selected from the group consisting of Mg, Fe, Ni, Co, W, Ta, and Mo. The respective subscripts in the composition formula are specified as follows: 0≤x≤5, 0≤y<1, 0≤z≤2, and −0.3≤δ≤0.3.

Still other examples of the monoclinic niobium titanium oxide include, for example, Nb₂TiO₇, Nb₂Ti₂O₉, Nb₁₀Ti₂O₂₉, Nb₁₄TiO₃₇, and Nb₂₄TiO₆₂. The monoclinic niobium titanium oxide may be a substituted niobium titanium oxide, in which at least a part of Nb and/or Ti is substituted with a dopant. Examples of the substituent element include Na, K, Ca, Co, Ni, Si, P, V, Cr, Mo, Ta, Zr, Mn, Fe, Mg, B, Pb, Al, etc. The substituted niobium titanium oxide may include one species of substituent element, or may include two or more species of substituent element.

The sodium niobium titanium oxide includes, for example an orthorhombic Na-containing niobium titanium composite oxide represented by Li₂₊ₓNa₂₋ₐM4_{b}Ti_{6-c-d}Nb_{c}M5_{d}O_{14+δ}, where 0≤x≤4, 0≤a<2, 0≤b<2, 0<c<6, 0≤d<3, c+d<6, and −0.5≤δ≤0.5, M4 includes one or more selected from the group consisting of Cs, K, Sr, Ba and Ca, and M5 includes one or more selected from the group consisting of Zr, Sn, V, Ta, Mo, W, Fe, Co, Mn, and Al.

As the negative electrode active material, the titanium oxide of anatase structure, the titanium oxide of monoclinic structure, the lithium titanium oxide of spinel structure, or a mixture thereof is preferably used. By combining a negative electrode using such oxides as the negative electrode active material, for example, with a positive electrode using a lithium manganese composite oxide as positive electrode active material, high electromotive force can be obtained.

The negative electrode active material is contained in the negative electrode active material-containing layer, for example, in the form of particles. Negative electrode active material particles may be single primary particles, secondary particles which are agglomerates of the primary particles, or a mixture of single primary particles and secondary particles. The shape of the particles is not particularly limited, and may be, for example, a spherical shape, an elliptical shape, a flat shape, a fibrous shape, or the like.

An average partile size (diameter) of primary particles of the negative electrode active material is preferably 3 μm or less, and a more preferable average primary particle size is 0.01 μm to 1 μm. An average particle size (diameter) of secondary particles of the negative electrode active material is preferably 30 μm or less, and a more preferable average secondary particle size is 5 μm to 20 μm.

The primary particle size and secondary particle size indicated here means a particle size with which a volume accumulated value becomes 50% in a particle size distribution obtained by a laser diffraction particle size distribution measuring apparatus. As the laser diffraction particle size distribution measuring apparatus, Shimadzu SALD-300 is used, for example. For measurement, luminous intensity distribution is measured 64 times at intervals of 2 seconds. As a sample used when performing the particle size distribution measurement, a dispersion obtained by diluting the negative electrode active material particles with N-methyl-2-pyrrolidone such that the concentration becomes 0.1 mass % to 1 mass % is used. Alternatively, a measurement sample obtained by dispersing 0.1g of a negative electrode active material in 1 ml to 2 ml of distilled water containing a surfactant is used.

The electro-conductive agent is added to increase the current-collecting performance and suppress the contact resistance between the active material and the current collector. Examples of the electro-conductive agent include carbonaceous materials such as vapor grown carbon fiber (VGCF), carbon black such as acetylene black, and graphite.

Other than that, fibrous carbon materials like carbon nanotubes and carbon nanofibers may be used as the electro-conductive agent. One of these may be used as the electro-conductive agent, or alternatively, two or more may be combined and used as the electro-conductive agent. Alternatively, instead of using the electro-conductive agent, surfaces of the active material particles may be subjected to carbon coating or electron conductive inorganic material coating.

The binder is added to fill gaps between dispersed active materials and to bind the active material and the negative electrode current collector. Examples of the binder include polytetrafluoroethylene (PTFE), polyvinylidene fluoride (PVdF), fluororubber, styrene butadiene rubber, polyacrylate compounds, imide compounds, carboxymethyl cellulose (CMC), and salts of CMC. One of these may be used as the binder, or alternatively, two or more may be combined and used as the binder.

With regard to the blending proportions of the negative electrode active material, electro-conductive agent, and binder in the negative electrode active material-containing layer, it is preferable that the negative electrode active material is within the range of 70% by mass to 95% by mass, the electro-conductive agent is within the range of 3% by mass to 20% by mass, and the binder is within the range of 2% by mass to 10% by mass. When the blending ratio of the electro-conductive agent is 3% by mass or more, current-collecting performance of the negative electrode active material-containing layer can be improved. When the content of the binder is 2% by mass or more, sufficient electrode strength can be obtained. The binder may serve as an insulator. Therefore, when the content of the binder is 10% by mass or less, insulating section within the electrode can be reduced.

The density of the negative electrode active material-containing layer (excluding the current collector) is preferably in the range of 1.8 g/cm³ to 2.8 g/cm³. A negative electrode in which the density of the negative electrode active material-containing layer is within this range is excellent in energy density and retention of the aqueous electrolyte. The density of the negative electrode active material-containing layer is more preferably in the range of 2.1 g/cm³ to 2.6 g/cm³.

The negative electrode may be fabricated by, for example, the following method. First, a negative electrode active material, an electro-conductive agent, and a binder are suspended in a solvent to prepare a slurry. The slurry is applied onto one face or both of obverse and reverse faces of a negative electrode current collector. Next, the applied slurry is dried to obtain a stack of the negative electrode active material-containing layer and the negative electrode current collector. Then, the stack is pressed. In this manner, a negative electrode is fabricated.

### (2) Positive Electrode

The positive electrode may include a positive electrode current collector and a positive electrode active material-containing layer. The positive electrode active material-containing layer may be provided on a principal surface on one side of the positive electrode current collector or on principal surfaces on both of obverse and reverse sides. The positive electrode active material-containing layer may include a positive electrode active material, and optionally an electro-conductive agent and a binder.

As the positive electrode active material, for example, an oxide or sulfide may be used. The positive electrode may contain one species of compound alone as the positive electrode active material, or alternatively may contain two or more species of compounds in combination.

Examples of the oxide or sulfide include a compound capable of having an alkali metal or alkali metal ions be inserted and extracted.

Examples of such compounds include manganese dioxide (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphates having an olivine structure (e.g., LiₓFePO₄; 0<x≤1, LiₓFe_{1-y}Mn_{y}PO₄; 0<x≤1, 0<y<1, and LiₓCoPO₄; 0<x≤1), iron sulfate (Fe₂(SO₄)₃), vanadium oxides (e.g., V₂O₅), and lithium nickel cobalt manganese composite oxides (LiₓNi_{1-y-z}Co_{y}Mn_{z}O₂; 0<x≤1, 0<y≤1, 0<z<1, y+z<1).

Among the above compounds, examples of compounds more preferable as the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0x≤1), lithium nickel cobalt composite oxides (e.g., LiₓNi_{1-y}Co_{z}O₂; 0<x≤1, 0<y<1), lithium manganese nickel composite oxides having a spinel structure (e.g., LiₓMn_{2-y}Ni_{y}O₄; 0<x≤1, 0<y<2), lithium manganese cobalt composite oxides (e.g., LiₓMn_{y}Co_{1-y}O₂; 0≤x≤1, 0<y<1), lithium iron phosphates (e.g., LiₓFePO₄; 0<x≤1), and lithium nickel cobalt manganese composite oxides (LiₓNi_{1-y-z}Co_{y}Mn_{z}O₂; 0<x≤1, 0<y<1, 0<z<1, y+z<1). When these compounds are used as the positive electrode active material, the positive electrode potential can be increased.

The primary particle size of the positive electrode active material is preferably from 100 nm to 1 μm. The positive electrode active material having a primary particle size of 100 nm or more is easy to handle during industrial production. In the positive electrode active material having a primary particle size of 1 μm or less, in-solid diffusion of lithium ions can proceed smoothly.

The specific surface area of the positive electrode active material is preferably in the range of 0.1 m²/g to 10 m²/g. A positive electrode active material having the specific surface area of 0.1 m²/g or more can adequately secure insertion/extraction sites of Li ions. A positive electrode active material having the specific surface area of 10 m²/g or less is easy to handle in industrial production and also can ensure charge-and-discharge cycle performance.

The binder is added to fill gaps among the dispersed positive electrode active material and also to bind the positive electrode active material with the positive electrode current collector. Examples of the binder include polytetrafluoroethylene (PTFE), polyvinylidene fluoride (PVdF), fluororubber, polyacrylate compounds, imide compounds, carboxymethyl cellulose (CMC), and salts of CMC. One of these may be used as the binder, or alternatively, two or more may be used in combination as the binder.

The electro-conductive agent is added to improve current collecting performance and to suppress the contact resistance between the positive electrode active material and the positive electrode current collector. Examples of the electro-conductive agent include carbonaceous substances such as vapor grown carbon fiber (VGCF), carbon black such as acetylene black, and graphite. One of these may be used as the electro-conductive agent, or alternatively, two or more may be used in combination as the electro-conductive agent. The electro-conductive agent may be omitted, as well.

In the positive electrode active material-containing layer, the positive electrode active material and binder are preferably blended in proportions of 80% by mass to 98% by mass, and 2% by mass to 20% by mass, respectively.

By setting the amount of the binder to 2% by mass or more, sufficient electrode strength can be obtained. The binder may also function as an electrical insulator. Thus, if the amount of the binder is set to 20% by mass or less, the amount of electrical insulator contained in the electrode decreases, and thereby internal resistance can be decreased.

When an electro-conductive agent is added, the positive electrode active material, the binder, and the electro-conductive agent are preferably blended in proportions of 77% by mass to 95% by mass, 2% by mass to 20% by mass, and 3% by mass to 15% by mass, respectively.

By setting the amount of the electro-conductive agent to 3% by mass or more, the above-mentioned effects can be expressed. By setting the amount of the electro-conductive agent to 15% by mass or less, the proportion of the electro-conductive agent in contact with the electrolyte can be reduced. When this proportion is low, decomposition of the electrolyte can be reduced during storage under high temperatures.

The positive electrode current collector is preferably a metal foil of titanium, aluminum, and the like, or an alloy foil of aluminum alloy containing one or more selected from the group consisting of Mg, Ti, Zn, Ni, Cr, Mn, Fe, Cu, and Si.

A thickness of the positive electrode current collector is preferably 5 μm to 20 μm, and more preferably 15 μm or less.

In addition, the positive electrode current collector may include a portion on a surface thereof where the positive electrode active material-containing layer is not disposed thereon. The portion can serve as a positive electrode current collecting tab. Alternatively, a positive electrode current collecting tab separate from the positive electrode current collector may be electrically connected to the positive electrode.

The positive electrode may be fabricated by, for example, the following method. First, a positive electrode active material, electro-conductive agent, and binder are suspended in a solvent to prepare a slurry. The slurry is applied onto one face or both of obverse and reverse faces of a positive electrode current collector. Next, the applied slurry is dried to obtain a stack of the positive electrode active material-containing layer and the positive electrode current collector. Then, the stack is pressed. In this manner, a positive electrode is fabricated.

Alternatively, the positive electrode may be fabricated by the following method. First, a positive electrode active material, electro-conductive agent, and binder are mixed to obtain a mixture thereof. Next, the mixture is molded into a pellet form. Next, a positive electrode can be obtained by arranging these pellets on the positive electrode current collector.

### (3) Separation Layer

The separation layer is provided between the negative electrode and the positive electrode to prevent electrical contact between the negative electrode and the positive electrode. That is, the separation layer serves as a separator that electrically insulates the negative electrode from the positive electrode. Furthermore, the separation layer is in contact with at least the negative electrode, specifically, with the negative electrode active material-containing layer. The separation layer may also be in contact with the positive electrode.

As the separation layer, there may be used a membrane containing inorganic solid particles and a polymer material, for example, a composite membrane of inorganic solid particles and a polymer material, or an ion exchange membrane. The inorganic solid particles may be, for example, solid electrolyte particles, and the membrane may be a solid electrolyte membrane. The solid electrolyte membrane may be, for example, a solid electrolyte composite membrane formed using solid electrolyte particles and a polymer material, and casting them into film form.

The thickness of the separation layer is preferably 3 μm or more, more preferably 5 μm or more, and still more preferably 7 μm or more from the viewpoint that an internal short circuit is less likely to occur. The thickness of the separation layer is preferably 50 μm or less, more preferably 30 μm or less, and still more preferably 20 μm or less from the viewpoint of enhancing ion conductivity and energy density.

Examples of the inorganic solid particles that can be contained in the separation layer include: oxide ceramics such as alumina, silica, zirconia, yttria, magnesium oxide, calcium oxide, barium oxide, strontium oxide, and vanadium oxide; carbonates and sulfates such as sodium carbonate, potassium carbonate, magnesium carbonate, calcium carbonate, barium carbonate, lanthanum carbonate, cerium carbonate, calcium sulfate, magnesium sulfate, aluminum sulfate, gypsum, and barium sulfate; phosphates such as hydroxyapatite, lithium phosphate, zirconium phosphate, and titanium phosphate; and nitride ceramics such as silicon nitride, titanium nitride, and boron nitride. The inorganic particles described above may be in the form of a hydrate.

The inorganic solid particles preferably include solid electrolyte particles having ion conductivity of alkali metal ions. Specifically, inorganic solid particles having ion conductivity with respect to lithium ions and sodium ions are more preferable. The expression “having lithium ion conductivity” as used herein refers to exhibiting lithium ion conductivity of 1×10⁻⁶ S/cm or more at 25° C. The lithium ion conductivity can be measured by, for example, an alternating-current impedance method. By using such inorganic solid particles, a separation layer having lithium ion conductivity or sodium ion conductivity can be obtained.

Examples of the inorganic solid particles having lithium ion conductivity include oxide solid electrolytes and sulfide solid electrolytes. As the oxide solid electrolyte, a lithium phosphate solid electrolyte having a NASICON (Sodium (Na) Super Ionic Conductor) structure and represented by the general formula Li₁₊ₓMα₂(PO₄)₃ is preferably used. Ma in the above general formula is, for example, one or more selected from the group consisting of titanium (Ti), germanium (Ge), strontium (Sr), zirconium (Zr), tin (Sn), aluminum (Al), and calcium (Ca). The subscript x is within a range of 0≤x≤2.

Specific examples of the lithium phosphate solid electrolyte having the NASICON structure include: a LATP compound represented by Li₁₊ₓAlₓTi₂₋ₓ(PO₄)₃, where 0.1≤x≤0.5; a compound represented by Li₁₊ₓAl_{y}Mβ_{2-y}(PO₄)₃, where Mβ is one or more selected from the group consisting of Ti, Ge, Sr, Zr, Sn and Ca, 0≤x≤1 and 0≤y≤1; a compound represented by Li₁₊ₓAlₓGe₂₋ₓ(PO₄)₃, where 0≤x≤2; a compound represented by Li₁₊ₓAlₓZr₂₋ₓ(PO₄)₃, where 0≤x≤2; a compound represented by Li_{1+x+y}AlₓMγ₂₋ₓSi_{y}P_{3-y}O₁₂, where Mγ is one or more selected from the group consisting of Ti and Ge, 0<x≤2, and 0≤y<3; and a compound represented by Li₁₊₂ₓZr₁₋ₓCaₓ(PO₄)₃, where 0≤x<1. Li₁₊₂ₓZr₁₋ₓCaₓ(PO₄)₃ has high water resistance, low reducibility, and low cost, and hence is preferably used as inorganic solid electrolyte particles.

In addition to the lithium phosphate solid electrolyte, examples of the oxide solid electrolyte include: an amorphous LIPON compound represented by LiₓPO_{y}N_{z}, where 2.6≤x≤3.5, 1.9≤y≤3.8, and 0.1≤z≤1.3 (e.g., Li_{2.9}PO_{3.3}N_{0.46}); a compound represented by La₅₊ₓAₓLa₃₋ₓMδ₂O₁₂ having a garnet structure, where A is one or more selected from the group consisting of Ca, Sr and Ba, Mδ is one or more selected from the group consisting of Nb and Ta, and 0≤x≤0.5; a compound represented by Li₃Mδ₂₋ₓL₂O₁₂, where Mδ is one or more selected from the group consisting of Nb and Ta, L may contain Zr, and 0≤x≤0.5; a compound represented by Li₇₋₃ₓAlₓLa₃Zr₃O₁₂, where 0≤x≤0.5; a LLZ compound represented by Li₅₊ₓLa₃Mδ₂₋ₓZrₓO₁₂, where Mδ is one or more selected from the group consisting of Nb and Ta, and 0≤x≤2 (e.g., Li₇La₃Zr₂O₁₂); and a compound having a perovskite structure and represented by La_{2/3-x}LiₓTiO₃, where 0.3≤x≤0.7. The solid electrolyte may be used singly or in combination of two or more species thereof.

As the inorganic solid particles having ion conductivity of sodium ions, a sodium-containing solid electrolyte may be used. The sodium-containing solid electrolyte is excellent in ion conductivity of sodium ions. Examples of the sodium-containing solid electrolyte include β-alumina, sodium phosphorus sulfide, and sodium phosphorus oxides. The sodium ion-containing solid electrolyte is preferably in the form of glass ceramics.

The shape of the inorganic solid particles is not particularly limited, and may be, for example, spherical, elliptical, flat, or fibrous.

The average particle diameter of the inorganic solid particles is preferably 15 μm or less, and more preferably 12 μm or less. In a case where the average particle diameter of the inorganic solid particles is small, the denseness of the separation layer can be increased.

The average particle diameter of the inorganic solid particles is preferably 0.01 μm or more, and more preferably 0.1 μm or more. In a case where the average particle diameter of the inorganic solid particles is large, aggregation of particles tends to be suppressed.

Note that the average particle diameter of the inorganic solid particles means a particle size at which a volume-based accumulated value is 50% in a particle size distribution as determined by a laser diffraction type particle size distribution analyzer. As a sample for this particle size distribution measurement, a dispersion liquid obtained by diluting with ethanol so as to have the concentration of the inorganic solid particles be 0.01% by mass to 5% by mass is used.

In the separation layer, a single species of inorganic solid particles may be used, or multiple species thereof may be mixed and used.

The separation layer preferably contains the inorganic solid particles as a main component. The proportion of the inorganic solid particles within the separation layer is preferably 70% by mass or more, more preferably 80% by mass or more, and still more preferably 85% by mass or more from the viewpoint of enhancing the ion conductivity in the separation layer. The proportion of the inorganic solid particles within the separation layer is preferably 98% by mass or less, more preferably 95% by mass or less, and still more preferably 90% by mass or less from the viewpoint of increasing the membrane strength of the separation layer. The proportion of the inorganic solid particles within the separation layer can be calculated by thermogravimetric (TG) analysis.

The polymer material contained in the separation layer enhances the binding property between the inorganic solid particles. The weight average molecular weight of the polymer material is, for example, 3000 or more. With the weight average molecular weight of the polymer material of 3000 or more, the binding property of the inorganic solid particles is further enhanced. The weight average molecular weight of the polymer material is preferably 3000 or more and 5 million or less, more preferably 5000 or more and 2 million or less, and still more preferably 10,000 or more and 1 million or less. The weight average molecular weight of the polymer material can be determined by gel permeation chromatography (GPC).

The polymer material may be a polymer formed by single monomer units, a copolymer formed by plural monomer units, or a mixture thereof. The polymer material preferably contains a monomer unit composed of hydrocarbon having a functional group containing one or more selected from the group consisting of oxygen (O), sulfur (S), nitrogen (N), and fluorine (F). In the polymer material, a proportion taken into account by a portion composed of the monomer unit is preferably 70% by mole or more. Hereinafter, this monomer unit is referred to as a first monomer unit. In the copolymer, a monomer unit other than the first monomer unit is referred to as a second monomer unit. The copolymer of the first monomer unit and the second monomer unit may be an alternating copolymer, a random copolymer, or a block copolymer.

In the polymer material, if the proportion taken into account by the portion composed of the first monomer unit is lower than 70 mol. %, the water shielding property of the composite film is liable to deteriorate. In the polymer material, the proportion of the portion composed of the first monomer unit is preferably 90 mol. % or more. The polymer material is most preferably a polymer in which the proportion of the portion the first monomer unit is 100 mol. %, that is, a polymer formed only by the first monomer unit.

The first monomer unit may be a compound having as a side chain a functional group containing one or more elements selected from the group consisting of oxygen (O), sulfur (S), nitrogen (N), and fluorine (F), and having a main chain composed of carbon-carbon bonds. The hydrocarbon may include one or more functional groups containing one or more elements selected from the group consisting of oxygen (O), sulfur (S), nitrogen (N), and fluorine (F). The aforementioned functional group in the first monomer unit enhances the conductivity of alkali metal ions passing through the composite membrane.

The hydrocarbon included in the first monomer unit preferably includes a functional group containing one or more selected from the group consisting of oxygen (O), sulfur (S), and nitrogen (N). In a case where the first monomer unit includes such a functional group, the conductivity of alkali metal ions in the composite membrane tends to be further enhanced and the internal resistance tends to be reduced.

One or more selected from the group consisting of a formal group, a butyral group, a carboxymethyl ester group, an acetyl group, a carbonyl group, a hydroxyl group, and a fluoro group are preferably included as the functional group of the first monomer unit. More preferably, at least one of a carbonyl group and a hydroxyl group is included as the functional group of the first monomer unit, and still more preferably, both are included as the functional group of the first monomer unit. The first monomer unit can be represented by the

following formula.

[symbol]

CR₁R₂—CR₁R₂ [symbol] ₙ

In the above formula, R₁ is preferably selected from the group consisting of hydrogen (H), an alkyl group, and an amino group. R₂ is preferably selected from the group consisting of hydroxyl group (—OH), —OR₁, —COOR₁, —OCOR₁, —OCH(R₁)O—, —CN, —N(R₁)₃, and —SO₂R₁.

Examples of the first monomer unit include one or more selected from the group consisting of vinyl formal, vinyl alcohol, vinyl acetate, vinyl acetal, vinyl butyral, acrylic acid and derivatives thereof, methacrylic acid and derivatives thereof, acrylonitrile, acrylamide and derivatives thereof, styrene sulfonic acid, polyvinylidene fluoride, and tetrafluoroethylene.

The polymer material preferably contains one or more selected from the group consisting of polyvinyl formal, polyvinyl alcohol, polyvinyl acetal, polyvinyl butyral, polymethyl methacrylate, polyvinylidene fluoride, and polytetrafluoroethylene.

The second monomer unit is a compound other than the first monomer unit, that is, a compound that does not include a functional group containing one or more selected from the group consisting of oxygen (O), sulfur (S), nitrogen (N), and fluorine (F), or a compound that does include the functional group but is not a hydrocarbon.

Examples of the second monomer unit include ethylene oxide and styrene. Examples of the polymer formed by the second monomer unit include polyethylene oxide (PEO) and polystyrene (PS).

The species of functional groups contained in the first monomer unit and the second monomer unit can be identified by infrared spectroscopy (Fourier Transform Infrared Spectroscopy; FT-IR). Furthermore, whether the first monomer unit is composed of a hydrocarbon can be determined by nuclear magnetic resonance (NMR). In the copolymer of the first monomer unit and the second monomer unit, the proportion taken account for by the portion composed of the first monomer unit can be calculated by NMR.

The polymer material may contain an aqueous electrolyte. The proportion of the aqueous electrolyte that may be contained in the polymer material can be grasped based on a water absorption capacity, thereof. Here, the water absorption capacity of the polymer material refers to a value ([Mₚ′−Mₚ]/100) which is obtained in such a manner, where the polymer material is immersed in water at a temperature of 23° C. for 24 hours, and a value obtained by subtracting a mass Mₚ of the polymer material before immersion from a mass Mₚ′ of the polymer material after immersion is then divided by the mass Mₚ of the polymer material before immersion. The water absorption capacity of the polymer material is considered relevant to the polarity of the polymer material.

When a polymer material having a high water absorption capacity is used, alkali metal ion conductivity in the separation layer tends to be increased. Moreover, when a polymer material having a high water absorption capacity is used, the binding force between the inorganic solid particles and the polymer material is enhanced, so that the flexibility of the separation layer can be increased. The water absorption capacity of the polymer material is preferably 0.01% or more, more preferably 0.5% or more, and still more preferably 2% or more.

When a polymer material having a low water absorption capacity is used, the strength of the separation layer can be increased. That is, when the water absorption capacity of the polymer material is too high, the separation layer may swell due to the aqueous electrolyte. Moreover, when the water absorption capacity of the polymer material is too high, the polymer material in the separation layer may flow out into the aqueous electrolyte. The water absorption capacity of the polymer material is preferably 15% or less, more preferably 10% or less, still more preferably 7% or less, and particularly preferably 3% or less.

The proportion of the polymer material in the separation layer is preferably 1% by mass or more, more preferably 3% by mass or more, and still more preferably 10% by mass or more from the viewpoint of enhancing the flexibility of the separation layer. In addition, the denseness of the separation layer tends to be higher in a case where the proportion of the polymer material is higher.

In addition, the proportion of the polymer material in the separation layer is preferably 20% by mass or less, more preferably 10% by mass or less, and still more preferably 5% by mass or less from the viewpoint of enhancing the carrier ion conductivity in the separation layer. The proportion of the polymer material in the separation layer can be calculated by thermogravimetric (TG) analysis.

As the polymer material contained in the separation layer, a single species of polymer may be used, or multiple species may be mixed and used.

The separation layer may contain a plasticizer or an electrolyte salt in addition to the inorganic solid particles and the polymer material. For example, in a case where the separation layer contains an electrolyte salt, the alkali metal ion conductivity in the separation layer can be further enhanced.

The separation layer can be formed onto the negative electrode active material-containing layer, for example, as follows.

A slurry for forming the separation layer is prepared. The slurry for separation layer formation is obtained by stirring a mixture obtained by mixing inorganic solid particles, a polymer material, and a solvent.

As the solvent, a solvent capable of dissolving the polymer material is preferably used. Examples of the solvent include alcohols such as ethanol, methanol, isopropyl alcohol, normal propyl alcohol and benzyl alcohol; ketones such as acetone, methyl ethyl ketone, methyl isobutyl ketone, cyclohexanone and diacetone alcohol; esters such as ethyl acetate, methyl acetate, butyl acetate, ethyl lactate, methyl lactate and butyl lactate; ethers such as methyl Cellosolve, ethyl Cellosolve, butyl Cellosolve, 1,4-dioxane and tetrahydrofuran; glycols such as ethylene glycol monoethyl ether acetate, propylene glycol monomethyl ether acetate, butyl carbitol acetate, and ethyl carbitol acetate; glycol ethers such as methyl carbitol, ethyl carbitol, and butyl carbitol; aprotic polar solvents such as dimethylformamide, dimethylacetamide, acetonitrile, valeronitrile, N-methyl-2-pyrrolidone, N-ethyl-2-pyrrolidone and γ-butyrolactam; cyclic carboxylate esters such as gamma-butyrolactone, gamma-valerolactone, gamma-caprolactone and epsilon-caprolactone; and linear carbonate compounds such as dimethyl carbonate, diethyl carbonate, di-n-propyl carbonate, diisopropyl carbonate, n-propyl isopropyl carbonate, ethyl methyl carbonate, and methyl n-propyl carbonate.

The slurry for separation layer formation is applied onto, for example, the negative electrode active material-containing layer on one principal surface of the negative electrode by, for example, a doctor blade method to obtain a coating film. Alternatively, the slurry for separation layer formation may be applied onto the negative electrode active material-containing layers on principal surfaces on both of obverse and reverse surfaces of the negative electrode, to obtain a coating film on each principal surface. The slurries for separation layer formation applied onto each of the principal surfaces may have the same composition, or compositions that are different with respect of each other. The coating film(s) is dried at a temperature of 50° C. or more and 150° C. or less. In this manner, obtained is a stack where the dried coating film(s) is formed on the negative electrode active material-containing layer(s) on one face or both faces of the negative electrode.

Next, this stack is subjected to a roll-press treatment. Upon the roll-press treatment, for example, a press apparatus equipped with two rollers on upper and lower portions is used. By using such a press apparatus, in the case that coating films are disposed on both faces of the negative electrode, both coating films can simultaneously be subjected to pressing. At this time, the heating temperature of the roller can be appropriately varied depending on the desired structure.

In the manner described above, a negative electrode supporting separation layer(s) can be obtained. Note that the above-described press apparatus allows the coating films provided on both surfaces of the negative electrode to be simultaneously subjected to a roll press treatment, but the coating films may be subjected to the roll press treatment one by one. Even in a case where the coating films are provided on just one surface of the negative electrode as well, the above-described press apparatus equipped with two rollers on upper and lower portions may be used.

In addition, the formation of the negative electrode active material-containing layer(s) and formation of the separation layer(s) may be performed simultaneously. For example, after applying the slurry for forming the negative electrode active material-containing layer onto the negative electrode current collector, but before the slurry dries, the slurry for separation layer formation can be applied thereon. After drying both slurries, the stack is subjected to pressing as appropriate, whereby a negative electrode supporting the separation layer can be obtained.

### (4) Other Separator

As the other separator, there may be used, for example, a nonwoven fabric or a self-supporting porous film. As materials for the nonwoven fabric or the self-supporting porous film, for example, polyethylene (PE), polypropylene (PP), cellulose, or polyvinylidene fluoride (PVdF) is used. The other separator is preferably a nonwoven fabric formed of cellulose.

The thickness of the other separator is, for example, 1 μm or more and preferably 3 μm or more. The thicker the other separator, less likely does the internal short circuit of the secondary battery occur. The thickness of the other separator is, for example, 30 μm or less and preferably 10 μm or less. The thinner the other separator, the lower the internal resistance of the secondary battery, making the volume energy density of the secondary battery tend to increase.

### (5) Aqueous Electrolyte

The secondary battery according to the embodiment includes an aqueous electrolyte. At least a part of the aqueous electrolyte may be held in the electrode group. The aqueous electrolyte contains at least an aqueous solvent and an electrolyte salt.

The aqueous electrolyte is, for example, liquid. The liquid aqueous electrolyte is an aqueous solution prepared by dissolving an electrolyte salt as solute in an aqueous solvent. In the aqueous solution, the aqueous solvent amount is preferably 1 mol or more, and more preferably 3.5 mol or more, with respect to 1 mol of salt as solute.

As the aqueous solvent, a solution including water can be used. The solution including water may be pure water, or may be a mixed solvent of water and an organic solvent. The proportion of water included in the aqueous solvent is, for example, 50% by volume or more, and preferably, 90% by volume or more.

The aqueous electrolyte may be a gel electrolyte. The gel electrolyte is prepared by mixing the above-described liquid aqueous electrolyte and a polymeric compound to obtain a composite. As the polymeric compound, for example, polyvinylidene fluoride (PVdF), polyacrylonitrile (PAN), polyethylene oxide (PEO), and the like may be used.

Whether the aqueous electrolyte contains water can be examined by GC-MS (Gas Chromatography-Mass Spectrometry). The salt concentration and the water content in the aqueous electrolyte can be measured by, for example, ICP (Inductively Coupled Plasma) emission spectrometry. The molar concentration (mol/L) can be calculated by measuring a predetermined amount of aqueous electrolyte and calculating the concentration of contained salt. In addition, the number of moles of the solute and the solvent can be calculated by measuring the specific gravity of the aqueous electrolyte.

As the electrolyte salt, for example, lithium salts, sodium salts, and mixtures thereof may be used.

As the lithium salt, for example, lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis(trifluoromethanesulfonyl)imide (LiTFSI; LiN(SO₂CF₃)₂), lithium bis(fluorosulfonyl)imide (LiFSI; LiN(SO₂F)₂), lithium bis(oxalate)borate (LiBOB: LiB[(OCO)₂]₂), and the like may be used.

As the sodium salt, for example, sodium chloride (NaCl), sodium sulfate (Na₂SO₄), sodium hydroxide (NaOH), sodium nitrate (NaNO₃), sodium trifluoromethanesulfonylamide (NaTFSA), and the like may be used.

The mol concentration of lithium ions and sodium ions in the aqueous electrolyte is preferably 3 mol/L or more, preferably 6 mol/L or more, and preferably 12 mol/L or more. When the concentration of lithium ions and sodium ions in the aqueous electrolyte is high, electrolysis of the aqueous solvent at the negative electrode tends to be suppressed, and thus, there is a tendency for the hydrogen generation from the negative electrode to be little.

In addition, other than the lithium salt and sodium salt, a salt including the first metal element may be added to the aqueous electrolyte, as well. Specific examples include zinc salts like zinc chloride and zinc sulfate. By adding such a compound to the electrolyte solution and performing a later-described aging treatment and the like, there can be obtained a negative electrode composite having a large amount of the first metallic element contained in the boundary region between the negative electrode and the separation layer, in the form of sole metal or various compounds.

The aqueous electrolyte may further contain a water-soluble organic solvent. As the water-soluble organic solvent contained in the aqueous electrolyte, for example, at least one selected from the group consisting of, for example, N-methyl-2-pyrrolidone (NMP), methanol, ethanol, propanol, isopropanol, butanol, isobutyl alcohol, sec-butyl alcohol, tert-butanol, ethylene glycol, 1,2-dimethoxyethane, tetrahydrofuran (THF), 1,4-dioxane, acetone, ethyl methyl ketone, acetonitrile (AN), dimethylformamide, hexamethylphosphate triamide, triethylamine, pyridine, and dimethyl sulfoxide may be used.

As described above, the positive electrode and the negative electrode may contain a binder. Compounds that may be used as a binder include those that are not compatible with the above-mentioned water-soluble organic solvents. Therefore, precaution is taken with regard to a binder used for the positive and negative electrodes in accordance with the water-soluble organic solvent included in the aqueous electrolyte. For similar reasons, precaution is taken with regard to the polymer material that can be included in the separation layer and the polymeric compound included in the gel electrolyte, in the case the water-soluble organic solvent is used.

A pH of the aqueous electrolyte is preferably 3 to 14, and more preferably 4 to 13. The pH is a value measured at 25° C.

### (6) Container Member

As the container member that houses the negative electrode, positive electrode, separation layer and aqueous electrolyte, a metal container, a laminated film container or a resin container may be used.

As the metal container, a metal can made of nickel, iron, stainless steel, or the like and having a prismatic shape or a cylindrical shape may be used. As the resin container, a container made of polyethylene, polypropylene, or the like may be used.

The plate thickness of each of the resin container and the metal container preferably falls within the range of 0.05 mm to 1 mm. The plate thickness is more preferably 0.5 mm or less, and even more preferably 0.3 mm or less.

As the laminated film, for example, a multilayered film formed by covering a metal layer with resin layers may be used. Examples of the metal layer include a stainless steel foil, an aluminum foil, and an aluminum alloy foil. As the resin layer, a polymer such as polypropylene (PP), polyethylene (PE), nylon, or polyethylene terephthalate (PET) may be used. The thickness of the laminated film preferably falls within the range of 0.01 mm to 0.5 mm. The thickness of the laminated film is more preferably 0.2 mm or less.

### (7) Negative Electrode Terminal

The negative electrode terminal may be formed, for example, from a material that is electrochemically stable at the potential of alkali metal ion insertion-extraction for the negative electrode active material and having electrical conductivity. Specifically, the material for the negative electrode terminal may include zinc, copper, nickel, stainless steel, aluminum, or an aluminum alloy containing at least one element selected from the group consisting of Mg, Ti, Zn, Mn, Fe, Cu, and Si. As the material for the negative electrode terminal, zinc or a zinc alloy is preferably used. In order to reduce the contact resistance between the negative electrode terminal and the negative electrode current collector, the negative electrode terminal is preferably made of the same material as that of the negative electrode current collector.

### (8) Positive Electrode Terminal

The positive electrode terminal may be made, for example, from a material that is electrically stable in a potential range of 3 V to 4.5 V with respect to oxidation-reduction potential of lithium (vs. Li/Li⁺) and having electrical conductivity. Examples of the material for the positive electrode terminal include titanium, aluminum, or an aluminum alloy containing at least one element selected from the group consisting of Mg, Ti, Zn, Mn, Fe, Cu, and Si. In order to reduce the contact resistance between the positive electrode terminal and the positive electrode current collector, the positive electrode terminal is preferably made of the same material as that of the positive electrode current collector.

The secondary battery according to the embodiment may be used in various forms such as a prismatic shape, a cylindrical shape, a flat form, a thin form, and a coin form. In addition, the secondary battery may be a secondary battery having a bipolar structure. A secondary battery having a bipolar structure has an advantage of being able to produce a cell with in-series connection of multiple, using a single cell.

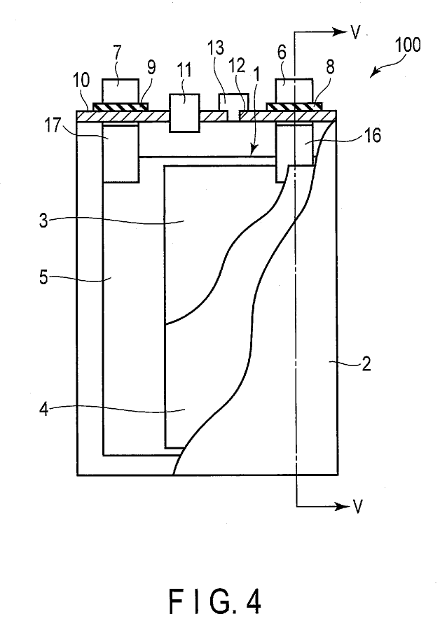

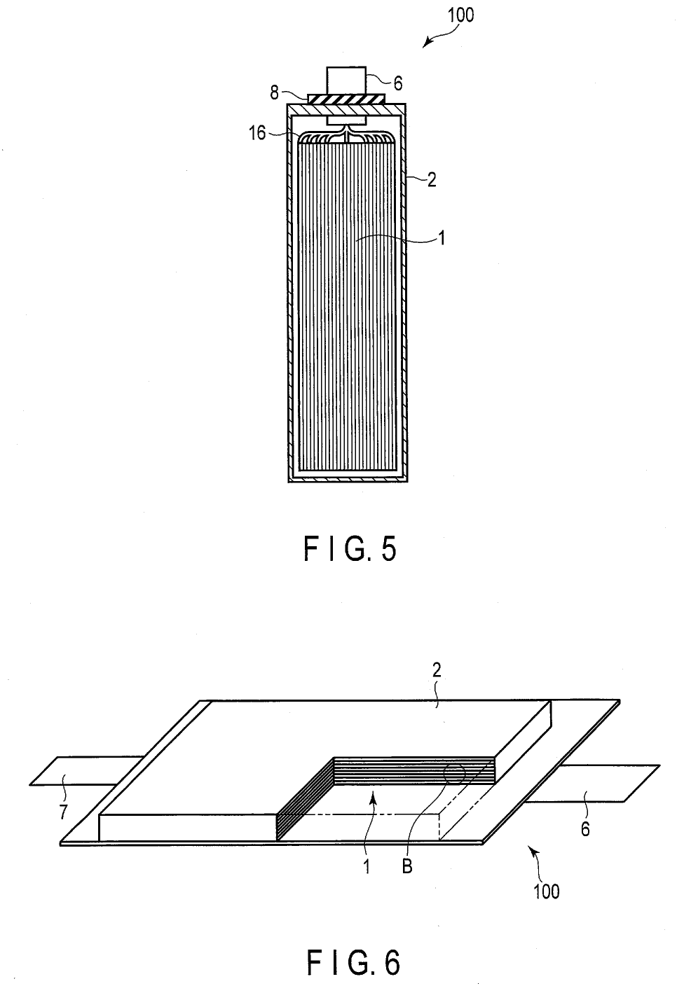

Details of the secondary battery according to the embodiment will be described below with reference to FIGS. 4 and 5. FIG. 4 is a sectional view schematically showing an example of the secondary battery according to the embodiment. FIG. 5 is a sectional view of the secondary battery shown in FIG. 4 taken along a line V-V.

An electrode group 1 is housed in a container member 2 made of a rectangular tubular metal container. The electrode group 1 includes a negative electrode 3, a separation layer 4, and a positive electrode 5. The separation layer 4 is disposed on a face of the negative electrode 3, so as to be positioned between the negative electrode 3 and positive electrode 5. The electrode group 1 has a structure formed by overlapping the positive electrode 5 and the negative electrode 3 having the separator 4 disposed thereon and spirally winding so as to form a flat shape. An aqueous electrolyte (not shown) is held by the electrode group 1. As shown in FIG. 4, a strip-shaped negative electrode lead 16 is electrically connected to each of plural portions at an end of the negative electrode 3 located on an end face of the electrode group 1. In addition, a strip-shaped positive electrode lead 17 is electrically connected to each of plural portions at an end of the positive electrode 5 located on the end face.

The plural negative electrode leads 16 are electrically connected to a negative electrode terminal 6 in a bundled state, as shown in FIG. 5. In addition, the plural positive electrode leads 17 are similarly electrically connected to a positive electrode terminal 7 in a bundled state, although not shown.

A sealing plate 10 made of metal is fixed to the opening portion of the container member 2 made of metal by welding or the like. The negative electrode terminal 6 and the positive electrode terminal 7 are extracted to the outside from outlets provided in the sealing plate 10. On the inner surfaces of the outlets of the sealing plate 10, a negative electrode gasket 8 and a positive electrode gasket 9 are arranged to avoid a short circuit caused by contact respective with the negative electrode terminal 6 and the positive electrode terminal 7. By providing the negative electrode gasket 8 and the positive electrode gasket 19, the airtightness of the secondary battery 100 can be maintained.

A control valve 11 (safety valve) is provided on the sealing plate 10. When the internal pressure of the battery cell is raised by gas generated by electrolysis of the aqueous solvent, the generated gas can be released from the control valve 11 to the outside. As the control valve 11 there may be used, for example, a return type valve that operates when the internal pressure exceeds a predetermined value and functions as a sealing plug when the internal pressure lowers. Alternatively, there may be used a non-return type valve that cannot recover the function as a sealing plug once it operates. In FIG. 4, the control valve 11 is disposed in the middle of the sealing plate 10. However, the position of the control valve 11 may be an end of the sealing plate 10. The control valve 11 may be omitted.

Additionally, an inlet 12 is provided on the sealing plate 10. The aqueous electrolyte may be put in via the inlet 12. The inlet 12 may be closed with a sealing plug 13 after the aqueous electrolyte is put in. The inlet 12 and the sealing plug 13 may be omitted.

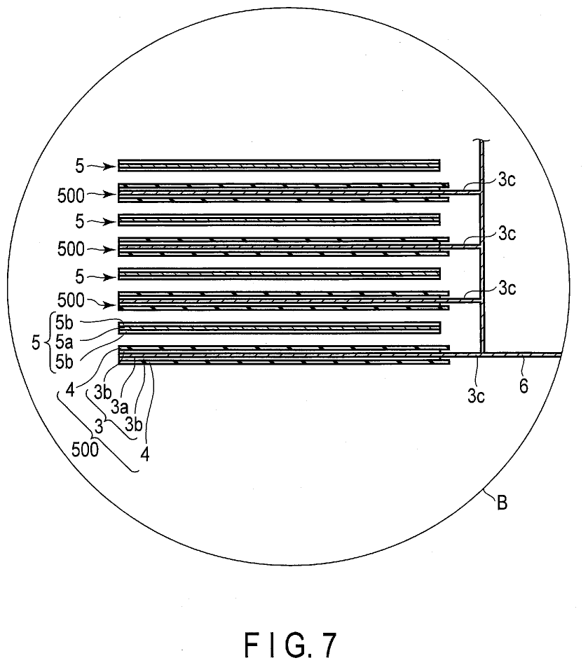

FIG. 6 is a partially cut out perspective view schematically showing another example of the secondary battery according to the embodiment. FIG. 7 is an enlarged sectional view of section B of the secondary battery shown in FIG. 6. FIG. 6 and FIG. 7 show an example of the secondary battery 100 using a laminated film container member as a container member.

The secondary battery 100 shown in FIGS. 6 and 7 includes an electrode group 1 shown in FIGS. 6 and 7, a container member 2 shown in FIG. 6, and an aqueous electrolyte, which is not shown. The electrode group 1 and the aqueous electrolyte are housed in the container member 2. The aqueous electrolyte is held in the electrode group 1.

The container member 2 is made of a laminated film including two resin layers and a metal layer sandwiched between the resin layers.

As shown in FIG. 7, the electrode group 1 is a stacked electrode group. The stacked electrode group 1 has a structure in which negative electrode composites 500 and positive electrodes 5 are alternately stacked.

The electrode group 1 includes plural negative electrode composites 500. Each of the negative electrode composites 500 include a negative electrode 3 and separation layers 4 supported on both faces of the negative electrode 3. Each negative electrode 3 includes a negative electrode current collector 3a and negative electrode active material-containing layers 3b arranged on both surfaces of the negative electrode current collector 3a. Each of the separation layers 4 are respectively supported on the negative electrode active material-containing layers 3b of the negative electrodes 3. The electrode group 1 further includes plural positive electrodes 5. Each of the positive electrodes 5 includes a positive electrode current collector 5a and positive electrode active material-containing layers 5b supported on both surfaces of the positive electrode current collector 5a.

The negative electrode current collector 3a of each of the negative electrodes 3 includes at one end, a portion where the negative electrode active material-containing layer 3b is not supported on any surface. The portion serves as a negative electrode current collecting tab 3c. As shown in FIG. 7, the negative electrode current collecting tab 3c does not overlap the positive electrode 5. Plural negative electrode current collecting tabs 3c are electrically connected to a belt-shaped negative electrode terminal 6. A leading end of the belt-shaped negative electrode terminal 6 is drawn to the outside from the container member 2.

Although not shown, the positive electrode current collector 5a of each of the positive electrodes 5 includes at one end a portion where the positive electrode active material-containing layer 5b is not supported on any surface. This portion serves as a positive electrode current collecting tab. Like the negative electrode current collecting tab 3c, the positive electrode current collecting tab does not overlap the negative electrode 3. Further, the positive electrode current collecting tab is located on the opposite side of the electrode group 1 with respect to the negative electrode current collecting tab 3c. The positive electrode current collecting tabs are electrically connected to a belt-shaped positive electrode terminal 7. A leading end of the belt-shaped positive electrode terminal 7 is located on the opposite side of the negative electrode terminal 6 and drawn to the outside from the container member 2.

### Measurement of Negative Electrode Active Material

The negative electrode active material included in the negative electrode can be identified by combining elemental analysis by SEM-EDX, ICP emission spectrometry, and X-ray diffraction (XRD) measurement. By SEM-EDX analysis, shapes of components contained in the active material-containing layer and composition ratios of the components contained in the active material-containing layer (each element from B to U in the periodic table) can be known. The elements in the active material-containing layer can be quantified by ICP measurement. Crystal structures of materials included in the active material-containing layer can be examined by XRD measurement.

The negative electrode composite is taken out from the battery by the method described above, and a cross-section of the negative electrode active material-containing layer is cut out by Ar ion milling. Several particles are selected from SEM images at 3000-fold magnification. Here, particles are selected such that a particle diameter distribution of the selected particles becomes as wide as possible.

Next, elemental analysis is performed on each selected particle by EDX. Accordingly, it is possible to specify species and quantities of elements other than Li among the elements contained in each selected particle.

With regard to Li, information regarding the Li content in the entire active material can be obtained by ICP emission spectrometry. ICP emission spectrometry is performed according to the following procedure.

From the dried negative electrode, a powder sample is prepared in the following manner. The negative electrode active material-containing layer is dislodged from the negative electrode current collector and ground in a mortar. The ground sample is dissolved with acid to prepare a liquid sample. Here, hydrochloric acid, nitric acid, sulfuric acid, hydrogen fluoride, and the like may be used as the acid. The components included in the active material being measured can be found by subjecting the liquid sample to ICP analysis.

Crystal structure(s) of compound(s) included in each of the particles selected by SEM can be specified by XRD measurement. XRD measurement is performed within a measurement range where 2θ is from 5 degrees to 90 degrees, using CuKa ray as a radiation source. By this measurement, X-ray diffraction patterns of compounds contained in the selected particles can be obtained.

As an apparatus for XRD measurement, SmartLab manufactured by Rigaku is used, for example. Measurement is performed under the following conditions:
X ray source: Cu target
Output: 45 kV, 200 mA
soller slit: 5 degrees in both incident light and received light
step width (2θ): 0.02 deg
scan speed: 20 deg/min
semiconductor detector: D/teX Ultra 250
sample plate holder: flat glass sample plate holder (0.5 mm thick)
measurement range: range of 5°≤2θ≤90°

When another apparatus is used, measurement using a standard Si powder for powder X-ray diffraction is performed, so as to find conditions that provide measurement results of peak intensity, half width, and diffraction angle that are equivalent to the results obtained by the above apparatus, and measurement of the sample is performed with those conditions.

Conditions of the XRD measurement is set, such that an XRD pattern applicable to Rietveld analysis is obtained. In order to collect data for Rietveld analysis, specifically, the step width is made ⅓ to ⅕ of the minimum half width of the diffraction peaks, and the measurement time or X-ray intensity is appropriately adjusted in such a manner that the intensity at the peak position of strongest reflected intensity is 5,000 cps or more.

The XRD pattern obtained as described above is analyzed by the Rietveld method. In the Rietveld method, the diffraction pattern is calculated from the crystal structure model that has been estimated in advance. Here, estimation of the crystal structure model is performed based on analysis results of EDX and ICP. The parameters of the crystal structure (lattice constant, atomic coordinate, occupancy ratio, or the like) can be precisely analyzed by fitting all the calculated values with the measured values.

XRD measurement can be performed with the negative electrode sample directly attached onto a glass holder of a wide-angle X-ray diffraction apparatus. At this time, an XRD spectrum is measured in advance in accordance with the species of metal foil as the negative electrode current collector, and the position(s) of appearance of the peak(s) derived from the collector is grasped. In addition, the presence/absence of peak(s) of mixed substances such as an electro-conductive agent or a binder is also grasped in advance. If the peak(s) of the current collector overlaps the peak(s) of the active material, the measurement is desirably performed with the active material-containing layer separated from the current collector. This is in order to separate the overlapping peaks when quantitatively measuring the peak intensities. If the overlapping peaks can be grasped beforehand, the above operations can be omitted, as a matter of course.

### Measurements of the Water-soluble Organic Solvent

The identification and quantification of the water-soluble organic solvent in an aqueous electrolyte can be carried out by liquid chromatography-mass spectrometry (LC/MS) analysis.

After discharging the battery, the battery is disassembled, and the electrode group is taken out. The electrolyte in the electrode group is extracted. By analyzing the extracted electrolyte by LC/MS, components in the electrolyte, for example, the organic solvent can be identified and quantified.

### Measurement Method of pH of Aqueous Electrolyte

The measurement method of the pH of the aqueous electrolyte is as follows. The electrolyte in the electrode group taken out from the disassembled battery is extracted, and after measuring the liquid amount, a pH value is measured using a pH meter. The pH measurement is performed, for example, as follows. For the measurement, F-74 manufactured by Horiba Seisakusho Co., Ltd. is used, for example. First, standard solutions of pH 4.0, 7.0, and 9.0 are prepared. Next, using these standard solutions, the F-74 is calibrated. An appropriately prepared amount of the electrolyte (electrolytic solution) to be measured is put in a container, and the pH is measured. After measuring the pH, the sensors of the F-74 are washed. When measuring a different subject for measurement, the above procedures, namely, the calibration, measurement, and washing are performed for each subject.

### Production Method

The secondary battery according to the embodiment can be produced as follows.

A negative electrode composite, a positive electrode, an aqueous electrolyte, and an optional other separator are prepared. The negative electrode composite, the positive electrode, the aqueous electrolyte, and the optional separator are used to assemble a battery. A salt containing the first metal element or a water-soluble organic solvent may be added to the aqueous electrolyte.

The assembled battery is subjected to an aging treatment in which a charge-and-discharge cycle is repeated under the following conditions. In an aging treatment in one method, a charge-and-discharge cycle is repeated at a low rate of 0.2 C or less. In an aging treatment in another method, cycles are repeated by stepwise charge-and-discharge where the charge capacity is increased step by step at a 1 C rate. In the case of performing aging by stepwise charge-and-discharge, for example, in the initial charge-and-discharge, the battery is charged up to a state of charge (SOC) of 50%, and as charge-and-discharge cycles are repeated, the SOC arrived upon charging is increased in a stepwise manner. At the end of aging, for example, the battery may be charged up to a SOC of 90% or more.

By performing the low-rate charge-and-discharge cycles or the stepwise charge-and-discharge cycles on the assembled battery, the secondary battery, in which the first metal element contained in the negative electrode active material-containing layer and the separation layer is localized in the boundary region, can be obtained. Specifically, the salt containing the first metal element that is added to the aqueous electrolyte, or a simple metal or a compound of the first metal element that is derived from the negative electrode current collector precipitates concentrated in the boundary region. Among the boundary region, the first metal element is more likely to precipitate in a portion that is a part of the negative electrode active material-containing layer. A simple substance or a compound of the first metal element may cover the surfaces of particles of the active material or the like contained in a portion among the negative electrode active material-containing layer that belongs to the boundary region. The first metal element derived from the negative electrode current collector may be, for example, that reprecipitated in the boundary region after eluting into the aqueous electrolyte during the aging treatment.

The secondary battery according to the first embodiment includes a negative electrode containing a titanium-containing oxide, a positive electrode, a separation layer between the negative electrode and the positive electrode, and an aqueous electrolyte. A first concentration of a first metal element (one or more among Hg, Pb, Zn, and Bi) in a boundary region between a negative electrode active material-containing layer of the negative electrode and the separation layer is 2 atom % to 8.2 atom %, and a ratio of the first concentration to a second concentration of the first metal element in portions within the negative electrode active material-containing layer other than the boundary region is 2.5 or more and less than 4. With the secondary battery, since electrolysis of water is suppressed at the negative electrode, high charge-discharge efficiency and high cycle life performance are exhibited.

### Second Embodiment

According to a second embodiment, a battery module is provided. The battery module includes plural of secondary batteries according to the first embodiment.

In the battery module, each of the single-batteries may be arranged to be electrically connected in series or in parallel, or may be arranged in combination of in-series connection and in-parallel connection.

An example of the battery module according to the embodiment will be described next with reference to the drawings.

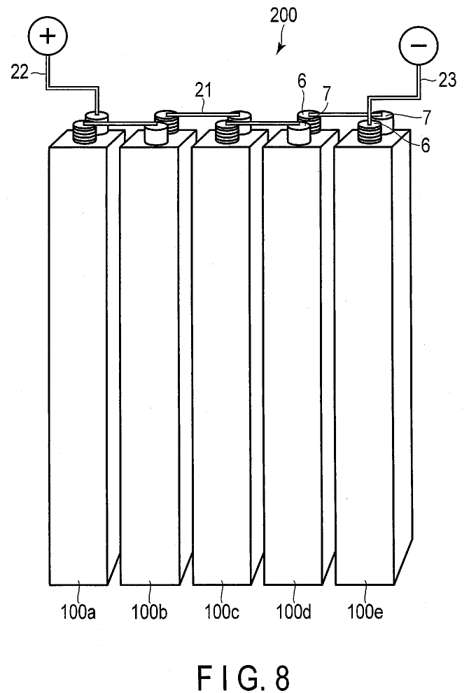

FIG. 8 is a perspective view schematically showing an example of the battery module. The battery module 200 shown in FIG. 8 includes five single-batteries 100a to 100e, four bus bars 21, a positive electrode-side lead 22, and a negative electrode-side lead 23. Each of the five single-batteries 100a to 100e is the secondary battery according to the first embodiment.

The bus bar 21 connects, for example, a negative electrode terminal 6 of one single-battery 100a and a positive electrode terminal 7 of the single-battery 100b positioned adjacent. In such a manner, five single-batteries 100 are thus connected in series by the four bus bars 21. That is, the battery module 200 shown in FIG. 8 is a battery module of five in-series connection. Although no example is depicted in drawing, in a battery module including plural single-batteries that are electrically connected in parallel, for example, the plural single-batteries may be electrically connected by having plural negative electrode terminals being connected to each other by bus bars while having plural positive electrode terminals being connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the second embodiment includes the secondary battery according to the first embodiment. Therefore, the battery module can exhibit high charge-discharge efficiency and high cycle life performance.

### Third Embodiment

According to a third embodiment, provided is a battery pack. The battery pack includes the battery module according to the second embodiment. The battery pack may include a single secondary battery according to the first embodiment, in place of the battery module according to the second embodiment.

The battery pack may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack may further include an external power distribution terminal. The external power distribution terminal is configured to externally output electric current from the secondary battery, and/or to input external electric current into the secondary battery. In other words, when the battery pack is used as a power source, electric current is provided out via the external power distribution terminal. When the battery pack is charged, the charging current (including regenerative energy of motive force of vehicles such as automobiles) is provided into the battery pack via the external power distribution terminal.

Next, an example of a battery pack according to the embodiment will be described with reference to the drawings.

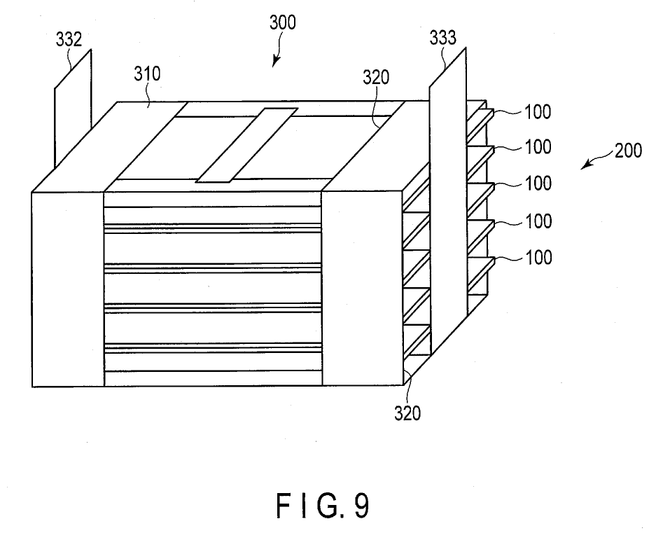

FIG. 9 is a perspective view schematically showing an example of the battery pack according to the embodiment.

A battery pack 300 includes a battery module configured of the secondary battery shown in FIGS. 6 and 7. The battery pack 300 includes a housing 310, and a battery module 200 housed in the housing 310. In the battery module 200, plural (for example, five) secondary batteries 100 are electrically connected in series. The secondary batteries 100 are stacked in a thickness direction. The housing 310 has an opening 320 on each of an upper portion and four side surfaces. The side surfaces, from which the positive and negative electrode terminals 6 and 7 of the secondary batteries 100 protrude, are exposed through the opening 320 of the housing 310. A positive electrode terminal 332 for output of the battery module 200 is belt-shaped, and one end thereof is electrically connected to any or all of the positive electrode terminals 7 of the secondary batteries 100, while the other end protrudes beyond the opening 320 of the housing 310 and thus protrudes past the upper portion of the housing 310. Meanwhile, a negative electrode terminal 333 for output of the battery module 200 is belt-shaped, and one end thereof is electrically connected to any or all of the negative electrode terminals 6 of the secondary batteries 100, while the other end protrudes beyond the opening 320 of the housing 310 and thus protrudes past the upper portion of the housing 310.

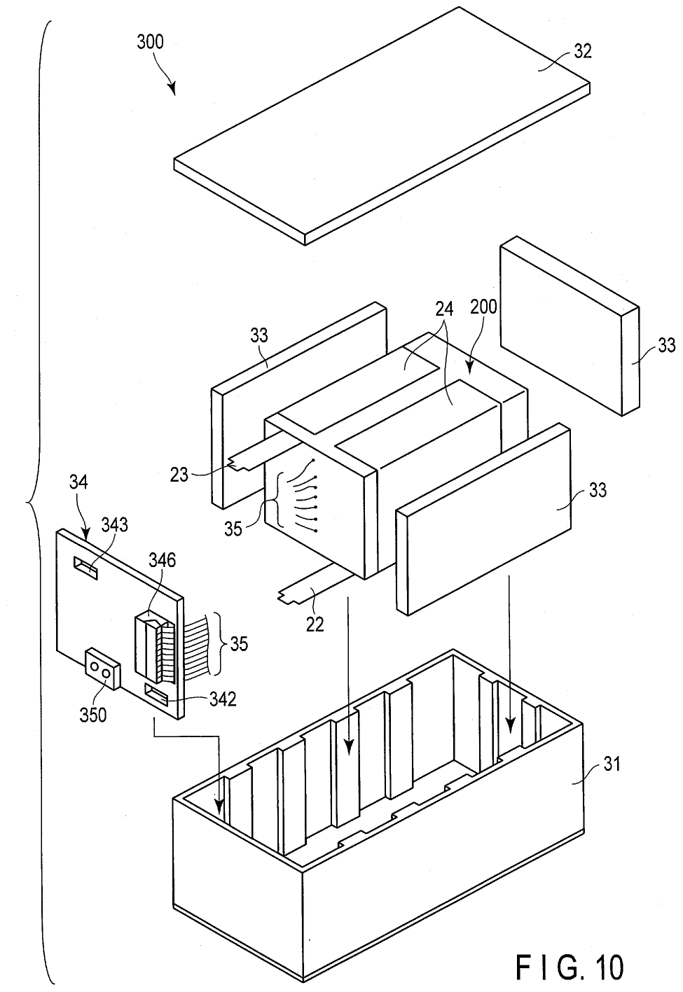

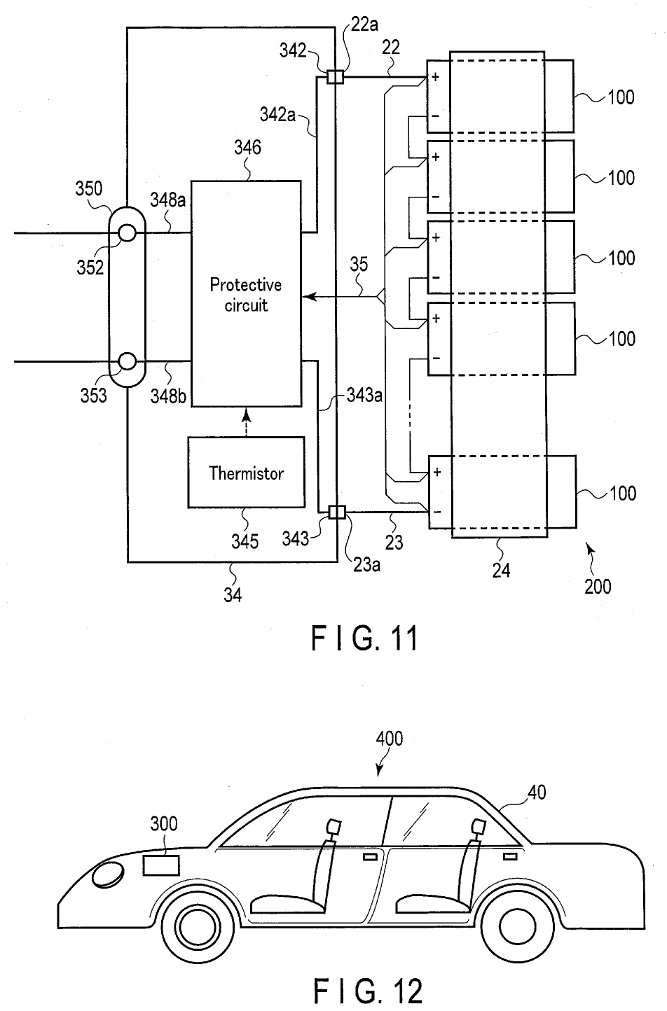

Another example of the battery pack is explained in detail with reference to FIG. 10 and FIG. 11. FIG. 10 is an exploded perspective view schematically showing another example of the battery pack according to the embodiment. FIG. 11 is a block diagram showing an example of an electric circuit of the battery pack shown in FIG. 10.

A battery pack 300 shown in FIGS. 10 and 11 includes a housing container 31, a lid 32, protective sheets 33, a battery module 200, a printed wiring board 34, wires 35, and an insulating plate (not shown).

The housing container 31 shown in FIG. 10 is a bottomed prismatic container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tape(s) 24.

At least one of the plural single-batteries 100 is a secondary battery according to the first embodiment. The plural single-batteries 100 are electrically connected in series, as shown in FIG. 11. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 24 fastens the plural single-batteries 100. The plural single-batteries 100 may be fixed using a heat shrinkable tape in place of the adhesive tape(s) 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces one side surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on an inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery(s) 100. When detecting over-charge or the like for each of the single-batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output electric current from the battery module 200 to an external device and input electric current from an external device to the battery module 200 via the external power distribution terminal 350. In other words, when using the battery pack 300 as a power source, the electric current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may respectively be used as the positive-side terminal and negative-side terminal of the external power distribution terminal.

Such a battery pack 300 is used, for example, in applications where excellent cycle performance is demanded when a large current is extracted. More specifically, the battery pack 300 is used as, for example, a power source for electronic devices, a stationary battery, or an onboard battery for various kinds of vehicles. An example of the electronic device is a digital camera. The battery pack 300 is particularly favorably used as an onboard battery.

The battery pack according to the third embodiment is provided with the secondary battery according to the first embodiment or the battery module according to the second embodiment. Accordingly, the battery pack can exhibit high charge-discharge efficiency and high cycle life performance.

### Fourth Embodiment

According to a fourth embodiment, a vehicle is provided. The vehicle has the battery pack according to the third embodiment installed thereon.

In the vehicle, the battery pack is configured, for example, to recover regenerative energy from motive force of the vehicle. The vehicle may include a mechanism (a regenerator) for converting kinetic energy of the vehicle into regenerative energy.

Examples of the vehicle include two-wheeled to four-wheeled hybrid electric automobiles, two-wheeled to four-wheeled electric automobiles, power assisted bicycles, and railway cars.

The installing position of the battery pack in the vehicle is not particularly limited. For example, when installing the battery pack in an automobile, the battery pack may be installed in the engine compartment of the vehicle, in rear parts of the vehicle, or under seats.

The vehicle may have plural battery packs installed thereon. In such a case, batteries included in each of the battery packs may be electrically connected to each other in series, electrically connected in parallel, or electrically connected in a combination of in-series connection and in-parallel connection. For example, in a case where each battery pack includes a battery module, the battery modules may be electrically connected to each other in series, electrically connected in parallel, or electrically connected in a combination of in-series connection and in-parallel connection. Alternatively, in a case where each battery pack includes a single battery, each of the batteries may be electrically connected to each other in series, electrically connected in parallel, or electrically connected in a combination of in-series connection and in-parallel connection.

Next, an example of the vehicle according to the embodiment will be described with reference to the drawings.

FIG. 12 is a partially see-through diagram schematically showing an example of a vehicle according to the embodiment.

The vehicle 400 shown in FIG. 12 includes a vehicle body 40 and a battery pack 300 according to the third embodiment. In the example shown in FIG. 12, the vehicle 400 is a four-wheeled automobile.

This vehicle 400 may have plural battery packs 300 installed. In such a case, the batteries (single-batteries or battery modules) included in the battery packs 300 may be connected in series, connected in parallel, or connected in a combination of in-series connection and in-parallel connection.

In FIG. 12, given is an example where the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

The vehicle according to the fourth embodiment has the battery pack according to the third embodiment installed therein. Therefore, the vehicle is excellent in drive performance and high in reliability.

### Fifth Embodiment

According to a fifth embodiment, a stationary power supply is provided. The stationary power supply has the battery pack according to the third embodiment installed therein.

The stationary power supply may have the battery module according to the second embodiment or the secondary battery according to the first embodiment installed therein, instead of the battery pack according to the third embodiment. The stationary power supply according to the embodiment can realize high efficiency and high life.

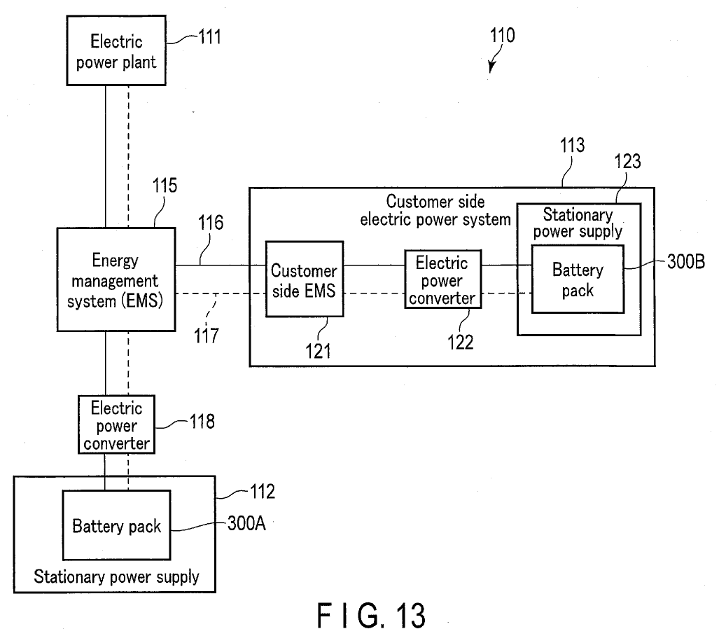

FIG. 13 is a block diagram showing an example of a system including the stationary power supply according to the embodiment. FIG. 13 is a diagram showing an application example to stationary power supplies 112, 123 as an example of use of battery packs 300A, 300B according to the third embodiment. In the example shown in FIG. 13, shown is a system 110 in which the stationary power supplies 112, 123 are used. The system 110 includes an electric power plant 111, the stationary power supply 112, a customer side electric power system 113, and an energy management system (EMS) 115. Moreover, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control to stabilize the entire system 110 by utilizing the electric power network 116 and the communication network 117.

The electric power plant 111 generates a large capacity of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current (DC) and alternate current (AC), conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

Note that the electric power stored in the battery pack 300B can be used, for example, for charging a vehicle such as an electric automobile. Also, the system 110 may be provided with a natural energy source. In such a case, the natural energy source generates electric power by natural energy such as wind power and solar light. In addition to the electric power plant 111, electric power is also supplied from the natural energy source through the electric power network 116.

### EXAMPLES

Examples are explained below, but the embodiments are not limited to examples described below.

### Example 1

### Fabrication of Negative Electrode

A negative electrode was fabricated in the following manner. A negative electrode active material, electro-conductive agent, and binder were dispersed in N-methyl-2-pyrrolidone (NMP) solvent, thereby preparing a negative electrode active material-containing slurry. The proportions of the electro-conductive agent and the binder in the negative electrode active material-containing layer were 5 parts by mass and 1 part by mass, respectively, with respect to 100 parts by mass of the negative electrode active material. As the negative electrode active material, lithium titanium oxide Li₄Ti₅O₁₂ powder having a spinel structure was used. As the electro-conductive agent, graphite powder was used. As the binder, polyvinylidene fluoride (PVdF) resin was used.

Next, the prepared slurry was applied onto both surfaces of a negative electrode current collector and the applied coat was dried, thereby forming the negative electrode active material-containing layer. As the negative electrode current collector, Zn foil having a thickness of 50 μm was used. The applied amount of slurry was 100 g/m² per side.

Next, inorganic solid particles and polymer material were mixed with NMP to obtain a slurry for separation layer formation. As the inorganic solid particles, LATP (Li_{1.5}Al_{0.5}Ti_{1.5}(PO₄)₃) particles having Li conductivity were used, and PVdF resin was used as the polymer material. In the separation layer slurry, the mass ratio of the inorganic solid particles to the polymer material was set to 80:20. This separation layer slurry was applied onto the surface of the negative electrode active material-containing layer, and the obtained applied coat was dried at a temperature of 130° C., thereby forming the separation layer on the negative electrode active material-containing layer, and this stack was pressed at 29 tons (when rolling) using a small-sized roll-press, thereby obtaining the negative electrode sheet supporting the separation layer having a thickness of 30 μm. The obtained negative electrode sheet was cut, yielding plural negative electrode composites having dimensions of a width of 6.8 cm and a length of 8.8 cm.

### Fabrication of Positive Electrode

A positive electrode active material, electro-conductive agent, binder, and solvent were mixed together to prepare a slurry for positive electrode fabrication. As the positive electrode active material, lithium nickel cobalt manganese composite oxide LiNi₅Co₂Mn₃O₂ was used. As the electro-conductive agent, acetylene black and graphite powder were used. As the binder, PVdF was used. As the solvent, NMP was used. The mass ratio of the positive electrode active material, electro-conductive agents, and binder in the slurry was set to 300:10:5:15. The slurry for positive electrode fabrication was applied onto both faces of a Ti foil having a thickness of 12 μm used as the positive electrode current collector, and dried to form a positive electrode active material-containing layer. The applied amount of slurry was 220 g/m² per face. A positive electrode sheet obtained in this manner was cut, yielding plural positive electrodes having dimensions of a width of 6.7 cm and a length of 8.7 cm.

### Fabrication of Electrode Group

As a separator separate from the separation layer, a nonwoven fabric made of cellulose was prepared. The negative electrode composites and the positive electrodes were stacked with the nonwoven fabric separators interposed therebetween to obtain an electrode group of stacked structure.

### Preparation of Electrolyte

A solution was prepared by dissolving 12 mol/L of LiCl in water. NMP was mixed into this solution in a proportion of 10% by volume with respect to the whole solution. To the obtained solution mixture, 0.1 mol/L of LiCl was added and dissolved. To this solution was further added 0.1% by mass of ZnCl₂. As such, a LiCl 12 mol/L aqueous solution including 10% by volume of NMP and 0.1% by mass of ZnCl₂ was obtained as a liquid aqueous electrolyte.

### Assembly of Battery

The electrode group produced as described above was inserted into a container made of laminated film. The liquid aqueous electrolyte prepared as described above was poured into the container. Thereby, the aqueous electrolyte was made to be held in the electrode group. Next, the container was sealed, whereby a secondary battery was obtained.

### Aging

The obtained secondary battery was subjected to the aging treatment at a low charge-discharge rate as follows.

The battery was charged at a constant current to a battery voltage of 2.55 V, and then discharged at a constant current to 1.8 V. A set of one charging and one discharging was taken as one cycle, and charge-and-discharge cycles were repeated. The charge-discharge rates (in C-rate) up to the sixth cycle are shown in the following Table 1. The charge-discharge efficiency at each charge-and-discharge cycle is also shown in Table 1. The charge-discharge efficiency was determined by dividing the discharge capacity by the charge capacity (charge-discharge efficiency (%)=[discharge capacity/charge capacity]×100%).

TABLE 1

| | Charge-discharge | Charge-discharge |
|---|---|---|
| Low-rate aging | rate | efficiency |
| in Example 1 | (C) | (%) |
| First cycle | 0.2 | 78 |
| Second cycle | 0.2 | 88 |
| Third cycle | 0.2 | 90 |
| Fourth cycle | 0.2 | 90 |
| Fifth cycle | 0.2 | 89 |
| Sixth cycle | 0.1 | 81 |

### Example 2

The procedure until the assembling of the battery was conducted in the same manner as in Example 1 to prepare a secondary battery. The obtained secondary battery was subjected to the following stepwise charge-and-discharge.

### Stepwise Charge-and-Discharge

Charge-and-discharge cycles in which constant current charging was conducted at 1 C and then constant current discharging was conducted at 1 C to 1.8 V, while the charged capacity was increased in a stepwise manner every several cycles was repeated as follows. Specifically, a state of charge (SOC) as a condition for charge cut-off was increased step by step first from 50%, then 60%, followed by 70% and finally to 90%. The charge cut-off conditions in some of the charge-and-discharge cycles are shown in Table 2 below. The charge-discharge rate and the charge-discharge efficiency during each charge-and-discharge cycle are also shown in Table 2.

TABLE 2

| Stepwise | | Charge | Charge- |
|---|---|---|---|
| charge-and- | Charge- | cut-off | discharge |
| discharge | discharge | condition | efficiency |
| in Example 2 | rate (C) | (SOC) | (%) |
| First cycle | 1 C | 50% | 63 |
| Fifth cycle | 1 C | 50% | 97 |
| Sixth cycle | 1 C | 60% | 95 |
| Tenth cycle | 1 C | 60% | 96 |
| Eleventh cycle | 1 C | 70% | 95 |
| Fifteenth cycle | 1 C | 70% | 97 |
| Sixteenth cycle | 1 C | 90% | 96 |
| Twentieth cycle | 1 C | 90% | 97 |

### Measurement

Secondary batteries each manufactured in Example 1 and Example 2 were disassembled according to the procedure described above, and their respective negative electrode composites were taken out. A 2 mm×2 mm sample piece was cut out by the procedure described above, and a cross-section was polished by Ar ion milling. SEM-EDX analysis was performed on observation fields of view (each width: 0.1 mm) at two points in each of the obtained sample cross-section. Analysis results for Example 1 and Example 2 are shown in the following Tables 3 and 4, respectively. The columns “First metal concentration (%)” and “First concentration/second concentration” in Tables 3 and 4 each indicate values calculated by the above-described methods.

TABLE 3

| | | | | | | | First |
|---|---|---|---|---|---|---|---|
| SEM-EDX analysis results for | | Atomic concentration | | | | First metal | concentration/ |
| negative electrode composite | | (at. %) | | | | concentration | second |
| in Example 1 | | P | Ti | Al | Zn | (%) | concentration |
| First | Boundary region | 5.49 | 14.53 | 0.82 | 0.51 | 2.4 | 2.6 |
| field | Portion of rest of negative electrode | 0.12 | 20.28 | 0.02 | 0.28 | 1.4 | |
| of | active material-containing layer | | | | | | |
| view | on boundary-side | | | | | | |
| | Portion of rest of negative electrode | 0.08 | 24.88 | 0.02 | 0.13 | 0.5 | |
| | active material-containing layer | | | | | | |
| | on current collector-side | | | | | | |
| Second | Boundary region | 5.44 | 11.87 | 1.09 | 0.53 | 2.8 | 3.8 |
| field | Portion of rest of negative electrode | 0.12 | 21.82 | 0.1 | 0.16 | 0.7 | |
| of | active material-containing layer | | | | | | |
| view | on boundary-side | | | | | | |
| | Portion of rest of negative electrode | 0.05 | 21.92 | 0.01 | 0.17 | 0.8 | |
| | active material-containing layer | | | | | | |
| | on current collector-side | | | | | | |

TABLE 4

| | | | | | | | First |
|---|---|---|---|---|---|---|---|
| SEM-EDX analysis results for | | Atomic concentration | | | | First metal | concentration/ |
| negative electrode composite | | (at. %) | | | | concentration | second |
| in Example 2 | | P | Ti | Al | Zn | (%) | concentration |
| First | Boundary region | 7.1 | 16.63 | 1.56 | 2.01 | 7.4 | 3.2 |
| field | Portion of rest of negative electrode | 0.21 | 26.17 | 0.15 | 1.15 | 4.2 | |
| of | active material-containing layer | | | | | | |
| view | on boundary-side | | | | | | |
| | Portion of rest of negative electrode | 0.16 | 25.5 | 0.14 | 0.11 | 0.4 | |
| | active material-containing layer | | | | | | |
| | on current collector-side | | | | | | |
| Second | Boundary region | 6.71 | 16.5 | 1.34 | 2.15 | 8.1 | 3.0 |
| field | Portion of rest of negative electrode | 0.19 | 25.98 | 0.12 | 1.21 | 4.4 | |
| of | active material-containing layer | | | | | | |
| view | on boundary-side | | | | | | |
| | Portion of rest of negative electrode | 0.14 | 25.46 | 0.13 | 0.23 | 0.9 | |
| | active material-containing layer | | | | | | |
| | on current collector-side | | | | | | |

As shown by each of the results, in both batteries manufactured in Examples 1 and 2, the ratio of the first concentration to the second concentration of the first metal element (zinc, in Examples 1 and 2) was more than 2 in each field of view. Therefore, it can be seen that there was obtained a negative electrode composite with the first metal element localized in the boundary region between the negative electrode and the separation layer. In all the observation fields of view, the first concentration of the first metal element in the boundary region was within the range of 2% or more and 8.2% or less. For such Examples 1 and 2, the charge-discharge efficiency after repeating the charge-and-discharge cycles was high, as shown in Tables 1 and 2.

According to at least one embodiment and example described above, a secondary battery is provided. The secondary battery includes a negative electrode including a negative electrode active material-containing layer, a positive electrode, a separation layer positioned between the negative electrode and the positive electrode, and an aqueous electrolyte. The negative electrode active material-containing layer contains a titanium-containing oxide. The separation layer is in contact with the negative electrode. At least one of the negative electrode active material-containing layer and the separation layer contains one or more first metal elements selected from the group consisting of Hg, Pb, Zn, and Bi. A first concentration of the first metal element in a boundary region between the negative electrode active material-containing layer and the separation layer is 2% or more and 8.2% or less. A ratio of the first concentration with respect to a second concentration of the first metal element in regions of the rest of the negative electrode active material-containing layer excluding the boundary region is 2.5 or more and less than 4. As the secondary battery can suppress electrolysis of water at the negative electrode, the secondary battery exhibits high charge-discharge efficiency and high cycle life performance. Further, the secondary battery can provide a battery pack exhibiting high charge-discharge efficiency and high cycle life performance, and moreover, a vehicle and stationary power supply having the battery pack installed thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery, comprising:
a negative electrode, the negative electrode comprising a negative electrode active material-containing layer that contains a titanium-containing oxide;
a positive electrode;
a separation layer in contact with the negative electrode active material-containing layer and positioned between the negative electrode and the positive electrode; and
an aqueous electrolyte,
at least one of the negative electrode active material-containing layer and the separation layer containing one or more first metal element selected from the group consisting of Hg, Pb, Zn, and Bi,
a first concentration being 2% or more and 8.2% or less, the first concentration corresponding to a first metal concentration in a boundary region spanning over 10 μm in a thickness direction including a boundary between the negative electrode active material-containing layer and the separation layer, the first metal concentration being represented by Equation 1 below, and
a ratio of the first concentration to a second concentration being 2.5 or more and less than 4, the second concentration corresponding to the first metal concentration in a region among the negative electrode active material-containing layer excluding the boundary region:
first metal concentration=atomic concentration of first metal element/sum of atomic concentrations of elements B to U in periodic table excluding carbon and oxygen. Equation 1:

2. The secondary battery according to claim 1, wherein the first metal element includes at least Zn.

3. The secondary battery according to claim 1, wherein the separation layer exhibits lithium ion conductivity.

4. The secondary battery according to claim 1, wherein the separation layer comprises a membrane containing inorganic solid particles and a polymer material.

5. A battery pack comprising the secondary battery according to claim 1.

6. The battery pack according to claim 5, further comprising an external power distribution terminal and a protective circuit.

7. The battery pack according to claim 5, further comprising plural of the secondary battery, the secondary batteries being electrically connected in series, in parallel, or in combination of in-series connection and in-parallel connection.

8. A vehicle comprising the battery pack according to claim 5.

9. The vehicle according to claim 8, which comprises a mechanism configured to convert kinetic energy of the vehicle into regenerative energy.

10. A stationary power supply comprising the battery pack according to claim 5.
